(19) United States
(12) Patent Application Publication
(10) Pub. No.: US 2003/0174834 A1
(43) Pub. Date: Sep. 18, 2003

(54) Electronic apparatus

(76) Inventor: Shigeru Kida, Shiki-gun (JP)

Correspondence Address: BIRCH STEWART KOLASCH & BIRCH, PO BOX 747, FALLS CHURCH, VA, 22040-0747, US

(21) Appl. No.: 10/386,453

(22) Filed: Mar. 13, 2003

(30) Foreign Application Priority Data
Mar. 13, 2002 (JP) P2002-69110

(51) Int. Cl. H04M 1/00; H04M 9/00

(52) U.S. Cl. 379/428.01

(57) ABSTRACT

An object of the invention is to provide an electronic apparatus wherein a tilting portion is held at a desired angle in spite of a weight of the tilting portion and reduction in a holding force is prevented. A panel unit portion provided with a display portion is provided to be free in angular displacement relative to a telephone body, a sector-shaped rib contiguous to the panel unit portion is sandwiched between first and second sliding members on both sides on an axis of angular displacement, and the respective sliding members elastically come into surface contact with the rib. The panel unit portion is prevented from making angular displacement due to an own weight of the panel unit portion and held in a position of angular displacement desired by an operator.

### BACKGROUND OF THE INVENTION

1. Field of the Invention

The invention relates to an electronic apparatus, such as telephones, facsimiles, portable type information-processing apparatuses, or the like, having a displaying function as in liquid crystal and a sheet feeding function, and more particular, to an electronic apparatus, in which tilting mechanisms for a display portion and a sheet feeding portion of the electronic apparatus are made stable in a simple construction and adjustment of angles, at which the display portion and the sheet feeding portion are held, is made stable by stably holding angles of the display portion and the sheet feeding portion to provide favorable sliding qualities.

2. Description of the Related Art

Conventionally, there have existed electronic apparatuses having a display portion implemented by a liquid crystal display, or the like, and a tilting mechanism enabling an operator to adjust the display portion at an angle desired by the operator.

For example, with a prior art disclosed in Japanese Unexamined Patent Publication JP-A 9-160669 (1997), a shaft hole and a shaft are provided on a synthetic resin rotating-joining portion of a tilting portion housing, a pair of compression coil springs are mounted on a non-rotating member of a synthetic resin to be opposed to each other and to be enabled to be adjusted in compression with an adjuster, and a tilting mechanism, in which a shaft hole or a shaft of a rotating member adapted to tilt and a shaft or a shaft hole of the non-rotating member are fitted to each other, prevents the tilting portion from making angular displacement downward due to its own weight and is capable of optimum adjustment of a holding force affording a smooth angular displacement.

Also, according to Japanese Unexamined Patent Publication JP-A 2000-227763 (2000), a slide portion of angle holding means having an arcuate or U-shaped cross section and angle holding means for making a pressure contact force on a slide surface of a printed board, which constitutes a part of a body casing unit, enable a display portion, which constitutes a tilting portion, to maintain a tilt angle relative to an electronic apparatus body.

With the prior art disclosed in JP-A 9-160669, a mechanism is achieved, in which spring forces of the compression coil springs are adjusted by a change in position of the adjuster to change frictional forces on contact portions of the rotating member and the non-rotating member whereby the tilting portion is kept at a desired tile angle and can be caused to make angular displacement smoothly. When the display portion provided with the tilting mechanism becomes large in size and its weight is correspondingly increased, there is caused a problem that there is a need of increasing spring forces of the compression coil springs to increase frictional forces on the contact portions of the rotating member and the non-rotating member and an increase in spring forces of the compression coil springs necessitates an increase in strength of the rotating member and the non-rotating member, which leads to large-sizing and complexity of the constitution. Also, there is caused a problem that an increase in spring forces of the compression coil springs increases an external force for causing the tilting portion to make angular displacement, whereby smooth angular displacement is not made possible. Also, there is caused a problem that the contact portions of the rotating member and the non-rotating member wear much and wear of the contact portions decreases coefficients of friction and the holding force.

Also, the electronic apparatus disclosed in JP-A 2000-227763 involves a problem that since the slide rubber is constantly put in a line contact with the printed board irrespective of a magnitude of a tilt angle, a pressure contact force on the slide surface becomes constant to provide a weak brake holding force when a tilt angle is small, that is, the display portion is positioned at a low angle, and a holding force of the tilting mechanism is further decreased due to an advanced wear of parts and a change in coefficient of friction between the surfaces, which are attendant upon dispersion of parts, changes in ambient temperature and humidity, and an increase in the accumulated number of use of the tilt function, whereby the tilting portion not only closes the display portion due to the own weight thereof but also makes a shock sound even when a slight impact such as contact of a part of an operator's body with the electronic apparatus and an installation base acts.

### SUMMARY OF THE INVENTION

Accordingly, an object of the invention is to provide an electronic apparatus, in which a tilting portion can be held at a desired angle irrespective of its weight, reduction in a holding force is prevented, and smooth angular displacement is made possible.

The invention provides an electronic apparatus comprising an electronic apparatus body, a tilting portion supported in a support position on the electronic apparatus body to be capable of angular displacement around an axis of angular displacement, a projecting member projecting from the tilting portion in a direction perpendicular to the axis of angular displacement, and position holding means having a sliding member which elastically comes into surface contact with the projecting member in a different position from the support position.

According to the invention, when the tilting portion supported on the electronic apparatus body makes angular displacement relative to the electronic apparatus body, the projecting member together with the tilting portion makes angular displacement. A frictional force opposed to an external force for angular displacement is applied on the projecting member by the sliding member. The tilting portion contiguous to the projecting member is prevented from displacement until an external force exceeding the frictional force applied by the sliding member is applied thereon, and when an external force exceeding the frictional force is applied thereon, displacement of the tilting portion is allowed. A frictional force applied by the sliding member is set to be larger than an external force produced by an own weight, whereby the tilting portion can be prevented from undesirably making angular displacement due to the own weight.

Further, according to the invention, by causing the projecting member to make angular displacement in a state, in which the projecting member and the sliding member are brought not into line contact with each other but into surface contact with each other, the projecting member and the sliding member can be made to slide in a wide range. Thereby, wear of the projecting member and the sliding member caused by sliding can be reduced as compared with the case where the projecting member and the sliding member are brought into line contact with each other. Even if the projecting member and the sliding member would wear, changes in a frictional force between the projecting member and the sliding member, which would be caused by such wear, can be suppressed to a small degree. Accordingly, even when an action of angular displacement of the tilting portion is repeated over a long term, it is possible to prevent reduction in frictional force and to keep a holding force, which prevents the tilting portion from making angular displacement due to its own weight and holds the tilting portion at an optional angle.

Also, since the projecting member and the sliding member contact with each other in a different position from a position, in which the tilting portion is supported, an external force is prevented from acting in the support position of the tilting portion in a direction other than a direction of angular displacement. Thereby, it is possible to prevent damage to a portion of the tilting portion in the support position.

According to the invention, even in the case where the tilting portion becomes large in size and weight, the tilting portion can be surely held at an optional angle. Also, since the sliding member and the projecting member slide in a wide range, wear caused by sliding of the sliding member and the projecting member is reduced, and even in the case where an action of angular displacement of the tilting portion is repeated over a long term, a holding force for holding the tilting portion at an optional angle can be maintained.

Also, in the invention it is preferable that the projecting member has an arcuate, outer peripheral surface centering about the axis of angular displacement.

According to the invention, the projecting member has an arcuate, outer peripheral surface centering about the axis of angular displacement, so that a minimum strength required for holding angular displacement of the tilting portion is ensured in the projecting member and besides an exclusive region required for angular displacement can be effectively utilized, whereby the exclusive region can be decreased. Accordingly, it is possible to make the electronic apparatus small in size while ensuring the strength of the projecting member.

Also, according to the invention, the projecting member has an arcuate, outer peripheral surface centering about the axis of angular displacement, whereby an exclusive region required for angular displacement of the projecting member can be decreased to make the electronic apparatus small in size.

Also, in the invention it is preferable that the tilting portion is supported in the support position, which is axially symmetrical with respect to the projecting member, to be able to make angular displacement.

According to the invention, the support position is symmetrical with respect to the projecting member, so that when the tilting portion makes angular displacement, a reaction force given by the projecting member is uniformly applied to the support position. Thereby, it is possible to prevent any twisting force from being generated on the tilting portion to enable angular displacement of the tilting portion smoothly. Also, an external force is prevented from being concentrated on the one support position, thus enabling preventing breakage in the support position.

Also, according to the invention, a position, in which the tilting portion is supported, is symmetrical with respect to the projecting member in the axial direction, whereby it is possible to prevent any twisting force from being generated on the tilting portion to enable angular displacement of the tilting portion smoothly. Also, an external force is prevented from being concentrated on the one support position, thus enabling breakage in the support position.

Also, in the invention it is preferable that at least one of a slide portion of the sliding member on which the projecting member slides and a slide portion of the projecting member on which the sliding member slides, is formed to be roughened.

According to the invention, at least one of the respective slide portions is formed to be roughened, whereby a coefficient of friction between the projecting member and the sliding member can be increased, so that a maximum static frictional force being the product of the coefficient of friction and a pressing force, with which the sliding member presses the projecting member, can be increased. Thereby, even in the case where the tilting portion is large in weight, angular displacement of the tilting portion due to its own weight can be prevented.

Also, according to the invention, at least one of the respective slide portions is formed to be roughened, whereby it is possible to increase a frictional force acting between the projecting member and the sliding member. Thereby, even when the tilting portion is large in weight, it can be prevented from making angular displacement due to its own weight.

Also, in the invention it is preferable that at least one of a slide portion of the sliding member on which the projecting member slides and a slide portion of the projecting member on which the sliding member slides, is formed of a material providing a large coefficient of friction between the slide portions such that a frictional force capable of preventing displacement of the tilting portion due to its own weight can be obtained.

According to the invention, since the respective slide portions mutually perform surface contact to obtain a frictional force capable of preventing displacement of the tilting portion due to its own weight, angular displacement of the tilting portion is prevented by a frictional force, which resists an external force produced by the own weight, so that the tilting portion can be held in an optional position of angular displacement.

Also, according to the invention, at least one of the respective slide portions is formed from a material such that a frictional force capable of preventing displacement of the tilting portion due to its own weight can be obtained, whereby the tilting portion can be prevented from making angular displacement due to its own weight.

Also, in the invention it is preferable that a plurality of projections are formed on at least one of a slide portion of the sliding member on which the projecting member slides and a slide portion of the projecting member on which the sliding member slides, and the respective projections are formed to be asymmetrical in a circumferential direction.

According to the invention, since the projecting member makes angular displacement in the circumferential direction in a state, in which the respective projections formed on one of the slide portions are contacted by the other of the slide portions, when making angular displacement toward one side of the circumferential direction, the other of the slide portions gets over the respective projections from the other side of the circumferential direction to make angular displacement, and when making angular displacement toward the other side of the circumferential direction, the other of the slide portions gets over the respective projections from one side of the circumferential direction to make angular displacement. At this time, since the respective projections are formed to be asymmetrical in the circumferential direction, a state of contact when the other of the slide portions gets over the projection is different depending upon a direction of angular displacement and so the coefficient of friction can be made different in the case of displacement toward one side of the circumferential direction and in the case of displacement toward the other side of the circumferential direction.

Also, according to the invention, those projections formed to be asymmetrical in the circumferential direction are formed on at least one of the respective slide portions, whereby a state of mutual contact on the slide portions can be changed between the case where the tilting portion makes displacement toward one side of the circumferential direction and the case where the tilting portion makes displacement toward the other side of the circumferential direction, so that a frictional force can be varied in the case of angular displacement toward one side of the circumferential direction and in the case of angular displacement toward the other side of the circumferential direction.

Also, in the invention it is preferable that at least one of a slide portion of the sliding member on which the projecting member slides and a slide portion of the projecting member on which the sliding member slides, is configured such that a coefficient of friction between the slide portions is varied depending upon an angular position of the tilting portion.

According to the invention, at least one of the respective slide portions is configured such that the coefficient of friction between the slide portions is varied according to an angular position of the tilting portion, whereby a frictional force produced by the projecting member and the sliding member can be varied according to an angular position of the tilting portion. Thereby, a magnitude of an external force required for angular displacement of the tilting portion can be changed according to an angular position of the tilting portion. In the case where the tilting portion is positioned in an angular position corresponding to a region having a large coefficient of friction, a large external force is necessary to cause angular displacement. Also, in the case where the tilting portion is positioned in an angular position corresponding to a region having a small coefficient of friction, angular displacement is caused by a small external force. In this manner, a magnitude of an external force required for angular displacement can be changed according to an angular position of the tilting portion to improve convenience.

Also, according to the invention, at least one of the respective slide portions is configured such that a coefficient of friction between the slide portions is varied according to an angular position of the tilting portion, whereby a magnitude of an external force required for angular displacement of the tilting portion can be changed according to a predetermined angular position of the tilting portion to improve convenience.

Also, in the invention it is preferable that the coefficient of friction is increased as a location of the center of gravity of the tilting portion at the time of installation of the electronic apparatus becomes more distant from a vertical plane including the axis of angular displacement.

The tilting portion is displaced horizontally as its location of the center of gravity becomes more distant from the vertical plane including the axis of angular displacement, so that an external force given to the tilting portion by the own weight is increased. According to the invention, a coefficient of friction is increased to increase a frictional force as the tilting portion becomes more distant from the vertical plane. Thereby, as the tilting portion is displaced horizontally, a frictional force can be increased as an external force given to the tilting portion is increased, whereby angular displacement of the tilting portion can be surely prevented. Thereby, a simple configuration makes it possible to surely hold the tilting portion having been inclined at a desired inclination irrespective of a position of angular displacement of the tilting portion.

Also, according to the invention, a coefficient of friction is increased as a location of the center of gravity of the tilting portion becomes more distant from the vertical plane including the axis of angular displacement, so that the tilting portion can be surely prevented from making angular displacement due to its own weight. Accordingly, an appropriate holding force for the tilting portion having been inclined at a desired inclination can be always obtained irrespective of a position of angular displacement of the tilting portion.

Also, in the invention it is preferable that the position holding means comprises a spring force generating portion for giving a spring force to the sliding member in an energizing direction toward the projecting member along an axial direction such that as the sliding member is positioned upstream in the energizing direction, a large spring force is applied to the sliding member, and at least one of a slide portion of the sliding member on which the projecting member slides and a slide portion of the projecting member on which the sliding member slides, is formed to be inclined in one sense of the axial direction as it goes in one sense of the circumferential direction.

According to the invention, the sliding member is given a spring force in the axial direction by the spring force generating portion to come into surface contact with the projecting member, so that the projecting member makes angular displacement whereby the sliding member slides on the projecting member. Since at least one of surfaces of the slide portions is provided to be inclined, the projecting member makes angular displacement in one sense of the circumferential direction whereby the sliding member sliding on the slide portion of the projecting member slides along the inclined surface to go in one sense of the axial direction. Since the axial direction and the energizing direction correspond to each other, the sliding member moves in the axial direction to be displaced in the energizing direction.

As the sliding member is displaced upstream in the energizing direction, a spring force produced by the spring force generating portion is increased. Thereby, a pressing force, with which the sliding member presses the projecting member, is increased to enable increasing a frictional force. Also, as the sliding member is displaced downstream in the energizing direction, a frictional force can be decreased.

In this manner, a frictional force can be changed by changing a pressing force applied on the projecting member by the sliding member according to a direction, in which the projecting member makes angular displacement, so that a simple construction can cause an appropriate frictional force according to a state of the tilting portion without making a mechanism, by which displacement of the tilting portion is held, large in size.

Also, according to the invention, at least one of surfaces of the respective slide portions of the projecting member and the sliding member is provided to be inclined, the spring force generating portion generates a pressing force conformed to a position of the sliding member in the energizing direction. Thereby, a frictional force can be changed according to a direction, in which the projecting member makes angular displacement, and an appropriate frictional force can be provided according to a state of the tilting portion.

Also, in the invention it is preferable that the position holding means comprises two sliding members for elastically sandwiching therebetween the projecting member on both sides thereof in the axial direction.

According to the invention, the projecting member is sandwiched between the two sliding members opposed to each other in the axial direction to thereby be prevented from displacement in the axial direction. Thereby, even when the sliding members apply a large pressing force on the projecting member, the projecting member can be prevented from displacement in the axial direction, so that it is possible to apply a large pressing force on the projecting member. Thereby, a frictional force can be increased, so that even in the case where the tilting portion has a large own weight, it is possible to prevent angular displacement of the tilting portion caused by its own weight. Also, since the two sliding members sandwich therebetween the projecting member on both sides in the axial direction, a mechanism for holding the tilting portion including the projecting member and the sliding members is not made large in size and a large frictional force can be generated.

Also, since the projecting member is prevented from deforming in the axial direction, it is possible to prevent any twisting force from being generated on the tilting portion to prevent the tilting portion and its portion in the support position from being broken due to torsion.

Also, according to the invention, the projecting member is sandwiched between the two sliding members elastically, whereby the projecting member is prevented from deforming in the axial direction, and a large pressing force can be applied on the projecting member. Thereby, a frictional force can be increased, so that even in the case where the tilting portion has a large own weight, it is possible to prevent angular displacement of the tilting portion caused by its own weight.

Also, in the invention it is preferable that the position holding means comprises two sliding members held by a single holding member to be made a unit.

According to the invention, since the two sliding members are held by the holding member to be made a unit, by arranging the holding member, by which the two sliding members are held in a predetermined positional relationship, it is unnecessary to adjust the positional relationship between the two sliding members to arrange the sliding members on an electronic apparatus. Thereby, assembly and maintenance of electronic apparatuses can be facilitated.

Also, in the invention it is preferable that the holding member has flexibility and elasticity, and an elastic recovery force of the holding member causes the respective sliding members to elastically sandwich therebetween the projecting member.

According to the invention, since the holding member has flexibility and elasticity, and the elastic recovery force of the holding member causes the two sliding members to sandwich therebetween the projecting member, the holding member can also serve as means for giving the elasticity to the sliding members, so that there is no separate need of any spring force generating portion such as a compression coil spring. Thereby, the construction can be simplified, and assembly and maintenance of electronic apparatuses can be further facilitated.

Also, the two sliding members are held by the holding member to be made a unit, the holding member has flexibility and elasticity, and the elastic recovery force of the holding member causes the two sliding members to sandwich therebetween the projecting member. By arranging such holding member on an electronic apparatus, there is no need of adjusting positions, in which the two sliding members are arranged, and an electronic apparatus can be assembled with ease. Also, there is no separate need of any spring force generating portion for giving the elasticity to the sliding members, and so the construction can be simplified.

Also, in the invention it is preferable that the projecting member is sized in the axial direction such that a radially inward portion thereof is formed to be larger than a radially outward portion thereof.

According to the invention, since the projecting member is sized in the axial direction such that a radially inward portion thereof is formed to be larger than a radially outward portion thereof, a material for the entire projecting member is small in amount, the weight of the projecting member is suppressed, and besides the projecting member can be increased in strength. Thereby, even in the case where the tilting portion has a large weight, it is possible to prevent deformation and breakage of the projecting member.

Also, according to the invention, the radially inward portion of the projecting member is formed to be large as compared with the radially outward portion of the projecting member, whereby the projecting member can be maintained in strength while the weight of the projecting member is suppressed.

Also, in the invention it is preferable that the position holding means comprises a spring force generating portion for generating a spring force in an energizing direction in parallel to the axis of angular displacement and toward the projecting member, and a pressing force changing portion for changing a pressing force, with which the spring force generated by the spring force generating portion causes the sliding member to press the projecting member, between a case where the projecting member makes angular displacement in one sense of the circumferential direction and a case where the projecting member makes angular displacement in the other sense of the circumferential direction.

According to the invention, the pressing force changing portion changes a pressing force, with which the sliding member presses the projecting member, between a case where the projecting member makes angular displacement in one sense of the circumferential direction and a case where the projecting member makes angular displacement in the other sense of the circumferential direction. In this manner, a pressing force, which the sliding member gives the projecting member, is changed according to a direction, in which the projecting member makes angular displacement, whereby a frictional force can be changed, so that a simple construction can cause an appropriate frictional force according to a state of the tilting portion without making a mechanism, by which displacement of the tilting portion is held, large in size.

Also, according to the invention, the pressing force changing portion changes a pressing force, with which the sliding member presses the projecting member, whereby a frictional force can be changed according to a direction, in which the projecting member makes angular displacement, and an appropriate frictional force can be produced according to a state of the tilting portion.

Also, in the invention it is preferable that the pressing force changing portion comprises a fixed guide provided on an electronic apparatus body and a sliding-member guide provided on the sliding member, and the fixed guide and the sliding-member guide abut against each other in the circumferential direction, and at least one of the guides guides the other of the guides in one sense of the axial direction as it goes in one sense of the circumferential direction.

According to the invention, the sliding member is moved in one sense of the circumferential direction as the projecting member makes angular displacement in one sense of the circumferential direction. When the sliding member is moved in one sense of the circumferential direction, the sliding-member guide provided on the sliding member is guided by the fixed guide and the sliding member together with the sliding-member guide is displaced in one sense of the axial direction. Accordingly, in the case where the projecting member makes angular displacement in one sense of the circumferential direction, the sliding member is displaced in one sense of the axial direction. Since the axial direction and the energizing direction are the same as each other, the sliding member is moved in the axial direction whereby the sliding member is displaced in the energizing direction.

The sliding member is displaced upstream in the energizing direction whereby the sliding member is separated from the projecting member. Thereby, a pressing force, with which the sliding member presses the projecting member, is decreased to enable reducing a frictional force. Also, the sliding member is displaced downstream in the energizing direction whereby a frictional force can be increased.

In this manner, a pressing force, which the sliding member gives the projecting member, is changed according to a direction, in which the projecting member makes angular displacement, whereby a frictional force can be changed, so that a simple construction can cause an appropriate frictional force according to a state of the tilting portion without making a mechanism, by which displacement of the tilting portion is held, large in size.

Also, according to the invention, the fixed guide and the sliding-member guide enable the sliding member to be moved in the axial direction as the projecting member makes angular displacement, whereby a pressing force, which the sliding member gives the projecting member, is changed, a magnitude of a frictional force can be changed according to a direction, in which the projecting member makes angular displacement, and an appropriate frictional force can be generated according to a state of the tilting portion.

Also, in the invention it is preferable that the pressing force changing portion is configured such that a pressing force when a location of the center of gravity of the tilting portion at the time of installation of the electronic apparatus is displaced in a direction more distant from a vertical plane including the axis of angular displacement is made larger than a pressing force when the location of the center of gravity of the tilting portion at the time of installation of the electronic apparatus is displaced in a direction more close to the vertical plane including the axis of angular displacement.

The tilting portion is displaced horizontally as its location of the center of gravity becomes more distant from the vertical plane including the axis of angular displacement, and an external force given to the tilting portion by an own weight thereof is increased. According to the invention, the pressing force and the frictional force are increased as the tilting portion becomes more distant from the vertical plane. Thereby, as the tilting portion is displaced horizontally, the frictional force can be increased conformed to an increase in the external force given to the tilting portion, so that it is possible to surely prevent angular displacement of the tilting portion. Thereby, a simple construction can surely hold the tilting portion having been inclined at a desired angle irrespective of a position of angular displacement of the tilting portion.

Also, according to the invention, a pressing force, with which the sliding member presses the projecting member, is increased as a location of the center of gravity of the tilting portion becomes more distant from the vertical plane including the axis of angular displacement. Since a pressing force, with which the sliding member presses the projecting member, is increased as an external force tending to cause the tilting portion to make angular displacement due to its own weight is increased, it is possible to prevent the tilting portion from making angular displacement due to its own weight. Accordingly, irrespective of a position of angular displacement of the tilting portion, an appropriate holding force can be constantly obtained for the tilting portion having been inclined at a desired angle.

Also, in the invention it is preferable that the tilting portion comprises display means for displaying a picture image.

According to the invention, since the tilting portion comprises display means for displaying a picture image, an operator can cause the tilting portion to make angular displacement to a position where the operator is easy to check a display screen. Also, as described above, since the tilting portion can be arranged in a desired position irrespective of the weight and a position of angular displacement of the tilting portion, it can be preferably used even when the display means is large in size.

Also, in the invention it is preferable that the tilting portion comprises a sheet feeding portion for taking sheets into the electronic apparatus body from outside thereof.

According to the invention, the tilting portion comprises the sheet feeding portion, so that the sheet feeding portion can be caused to make angular displacement between a movable position, in which sheets are received, and an immovable position, in which sheets are not received, and which is close to the apparatus. Thereby, the electronic apparatus in an immovable state can be made small in size. Also, even when the number of sheets is increased, the tilting portion can be preferably used without making angular displacement due to a weight of a load.

Also, according to the invention, the tilting portion comprises the sheet feeding portion, so that the sheet feeding portion can be caused to make angular displacement between a movable position, in which sheets are received, and an immovable position, in which sheets are not received, and which is close to the apparatus. Thereby, the electronic apparatus in an immovable state can be made small in size. Also, even when the number of sheets received in the sheet feeding portion is increased to thereby increase a force tending to cause the tilting portion to make angular displacement, the tilting portion can be preferably used without making angular displacement.

In the invention it is preferable that at least one of the fixed guide and the sliding-member guide has an inclined surface which inclines relative to the axial direction, and an angle of inclination of the inclined surface relative to the axial direction is set in a range of from 30 degrees to 60 degrees.

According to the invention, the angle of inclination of the inclined surfaces on the at least one of the fixed guides and the sliding-member guides relative to the axial direction is set in the range of from 30 degrees to 60 degrees. Thereby, the tilting portion can be prevented from making angular displacement due to its own weight and make angular displacement in the opening direction with a small force of angular displacement. In the case where the angle of inclination is less than 30 degrees, frictional forces generated when the respective guides contact with each other become large, so that angular displacement cannot be made smooth when angular displacement is to be made in the opening direction. Also, in the case where the angle of inclination exceeds 60 degrees, the reaction forces generated on the guides are decreased, so that angular displacement cannot be made smooth when angular displacement is to be made in the opening direction.

### BRIEF DESCRIPTION OF THE DRAWINGS

Other and further objects, features, and advantages of the invention will be more explicit from the following detailed description taken with reference to the drawings wherein:

FIG. 1 is a perspective view showing an outward appearance of a telephone having a function as a facsimile, according to an embodiment of the invention;

FIG. 2 is a perspective view showing in enlarged scale a panel unit portion and its vicinity as viewed from a back surface side of the telephone;

FIG. 3 is a cross sectional view taken along the line III-III of the telephone shown in FIG. 2;

FIG. 4 is a cross sectional view showing an essential part of a telephone according to a further embodiment of the invention;

FIG. 5 is a cross sectional view showing an essential part of a telephone according to a still further embodiment of the invention;

FIGS. 6A to 6C are perspective views showing a first sliding member and an energizing casing of a telephone according to a further embodiment of the invention;

FIG. 7 is a cross sectional view showing in enlarged scale the telephone in a state, in which the first sliding member is received in the energizing casing;

FIG. 8 is a cross sectional view showing in enlarged scale a state, in which the first sliding member is received in the energizing casing;

FIG. 9 is a cross sectional view showing an essential part of a telephone according to a further embodiment of the invention;

FIG. 10 is a cross sectional view showing an essential part of a telephone according to a still further embodiment of the invention;

FIG. 11 is a cross sectional view showing an essential part of a telephone according to a further embodiment of the invention;

FIG. 12 is a cross sectional view showing a rib in a further embodiment of the invention; and

FIG. 13 is a cross sectional view showing a rib in a still further embodiment of the invention.

### DETAILED DESCRIPTION OF PREFERRED EMBODIMENTS

Now referring to the drawings, preferred embodiments of the invention are described below.

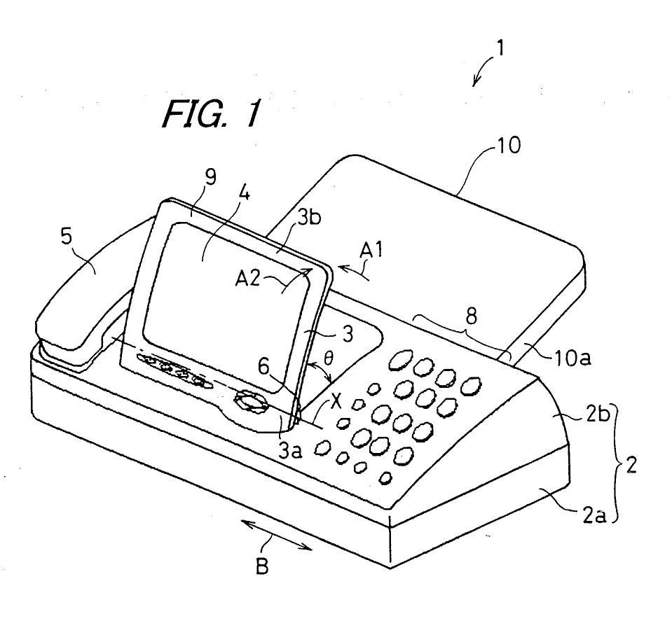

FIG. 1 is a perspective view showing an outward appearance of a telephone 1 having a facsimile function according to an embodiment of the invention. The telephone 1 as an electronic apparatus comprises a lower cabinet 2a and an upper cabinet 2b, which constitute a housing of a telephone body 2, and a panel unit portion 3 making a tilting portion, which is provided on the telephone body 2 to make a free angular displacement. The panel unit portion 3 comprises a display portion 4 formed in a substantially rectangular-plate shape and composed of a liquid crystal display unit. With the panel unit portion 3, a surface toward the upper cabinet 2b constitutes a back surface 11, and a surface opposed to the back surface 11 constitutes a front surface 9. A display surface is provided on the front surface 9 of the panel unit portion 3.

Provided on a base end 3a of the panel unit portion 3 toward the upper cabinet 2b are rotary bearings 6 to permit the panel unit portion 3 to make a free angular displacement. The rotary bearings 6 of the panel unit portion 3 are pivotally supported on the upper cabinet 2b to serve as a support position portion for the panel unit portion 3. An axis X of angular displacement of the panel unit portion 3 passes through the rotary bearings 6. The panel unit portion 3 is constructed to be able to be angularly displaced to an optional angular position within a predetermined angular range and to be held in the optional angular position, thus constituting a tilting mechanism described later. In order not to prevent angular displacement of the panel unit portion 3, which makes angular displacement, the upper cabinet 2b is formed in a portion except an exclusive space required for the panel unit portion 3 to make angular displacement.

The panel unit portion 3 can be opened by using fingers to apply an external force to the other side 3b opposed to the base end 3a of the panel unit portion 3 in an opening direction A1 away from the upper cabinet 2b, and the panel unit portion 3 can be closed by using fingers to apply an external force to the other side 3b of the panel unit portion 3 in a closing direction A2 toward the upper cabinet 2b.

In this manner, the telephone 1 is constructed such that by applying an external force for causing the panel unit portion 3 to make angular displacement, an operator can have the panel unit portion 3 making angular displacement to an angular position where the operator is easy to see the display portion 4, about an axis of angular displacement to hold the panel unit portion in the angular position.

Also, the telephone 1 is constructed to have a function as a facsimile telephone to be able to form a picture image on the basis of picture data given through a telephone line, and comprises a sheet feeding portion 10 for feeding sheets, which constitute a medium for forming a picture image, into the telephone body. Like the panel unit portion 3, the sheet feeding portion 10 is provided to be able to make a free angular displacement to the telephone body 2. The sheet feeding portion 10 is formed in a plate shape and rotary bearings provided on a base end 10a are pivotally supported on the lower cabinet 2a or the upper cabinet 2b. The sheet feeding portion 10 is also formed to be able to be held in an angular position, which an operator faces. For example, the sheet feeding portion 10 is configured to be able to make angular displacement at an angle suited to operability and an installation location. The telephone 1 has a basic construction in addition to the above, and comprises, for example, a telephone control key portion 8 for input of a telephone number and of a response command from outside of the telephone 1, and a handset unit 5.

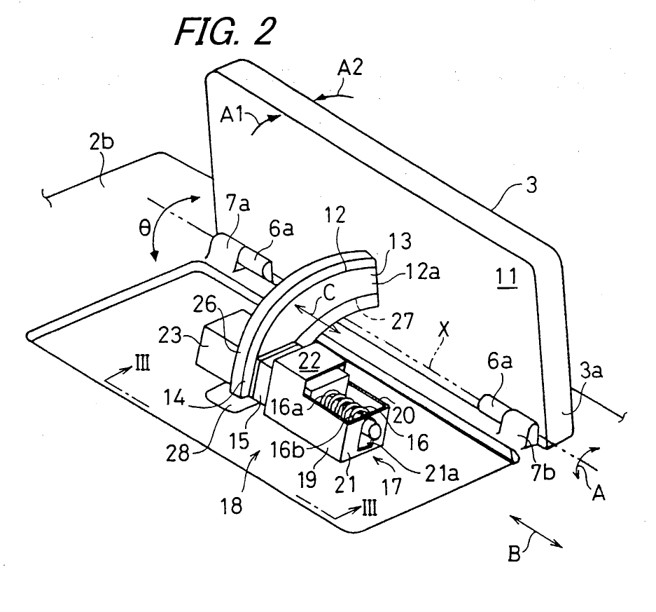

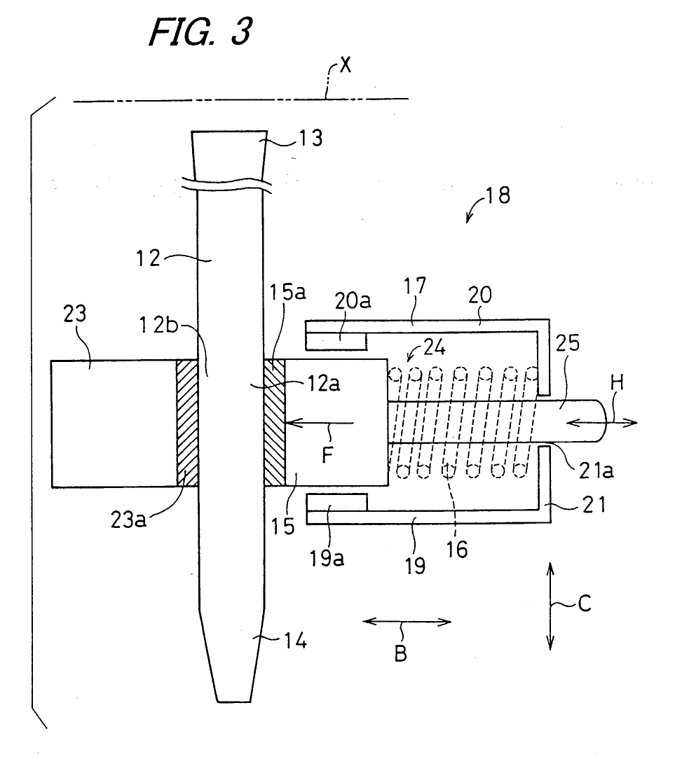

FIG. 2 is a perspective view showing in enlarged scale the panel unit portion 3 and its vicinity as viewed from the back surface side of the telephone 1. FIG. 3 is a cross sectional view taken along the line III-III of the telephone 1 shown in FIG. 2. In the invention, it is assumed that a direction of angular displacement about the axis X of angular displacement denotes a circumferential direction A, further one sense of the circumferential direction denotes an opening direction A1, in which the panel unit portion 3 goes away from the upper cabinet 2b, the other sense of the circumferential direction denotes a closing direction A2, in which the panel unit portion 3 approaches the upper cabinet 2b, and the opening direction A1 and the closing direction A2 together denote a circumferential direction A. The panel unit portion 3 is moved to a horizontal position as it goes toward the closing direction A2, and its center of gravity is moved to a vertical position including the axis of angular displacement as it goes toward the opening direction A1. Also, a direction in parallel to the axis X of angular displacement denotes an axial direction B.

The panel unit portion 3 is provided on the base end 3a thereof with two rotary bearings 6a, 6b, and the respective rotary bearings 6a, 6b are arranged on both sides of an axial direction X of the base end 3a. Also, formed in positions of the upper cabinet 2b opposed to the respective rotary bearings 6a, 6b are shaft portions 7a, 7b for pivotally supporting the respective rotary bearings 6a, 6b. The two rotary bearings 6a, 6b are pivotally supported by the respective shaft portions 7a, 7b whereby the panel unit portion 3 are configured to make a free angular displacement. The two rotary bearings 6a, 6b are aligned on the axis X of angular displacement, and the axis X of angular displacement is extended through both the rotary bearings 6a, 6b. Thereby, the panel unit portion 3 is provided to make a free angular displacement about the axis X of angular displacement.

Also, the telephone 1 comprises on a side of the back surface 11 of the panel unit portion 3, a rib 12 projecting from the panel unit portion 3, and a sliding member 15 for pressing the rib 12 in an axial direction B and elastically coming into surface contact with the rib. The rib 12 is a plate-shaped projecting member, which projects perpendicularly from the back surface 11 of the panel unit portion 3 and is arranged perpendicular to the axis X of angular displacement. The rib 12 is formed in a sector-plate shape, which is formed by cutting out a ring disk by two planes including radial lines of the ring disk, and has side surfaces, which are surrounded by two arcs having different radii from a center thereof and the same angle, and two sides connecting respective ends of the two arcs to each other, on both sides in an axial direction. The respective side surfaces are formed on planes perpendicular to the axis X of angular displacement. Also, the rib 12 has an arcuate, outer peripheral surface 26 centering about the axis X of angular displacement, and an arcuate, inner peripheral surface 27 centering about the axis X of angular displacement.

The rib 12 projects from a position distant from the base end 3a of the panel unit portion 3, for example, from a central portion of the panel unit portion 3 in a width direction and in a longitudinal direction, to be arranged in a central position of the two rotary bearings 6a, 6b in the axial direction B. In other words, the two rotary bearings 6a, 6b are arranged to be symmetrical in an axial direction B with respect to an imaginary plane including the rib 12 and perpendicular to the axis X of angular displacement. Also, the rib 12 is supported in a cantilevered manner such that in a state, in which the sliding member 15 is removed, one end 13 thereof in one sense of the circumferential direction is connected to the panel unit portion 3 and the other end 14 thereof in the other sense of the circumferential direction is made free. Also, the rib 12 is sized in the axial direction such that a radially inward side portion thereof is formed to be large as compared with a radially outward side portion thereof. Thereby, the rib 12 can be increased in strength.

The rib 12 is formed from a synthetic resin, for example, polystyrene, by means of the molding processing. The rib 12 may be molded integral with the panel unit portion 3, or may be mounted to the panel unit portion 3 after being formed from a different material, in a different shape, and with a different manufacturing method from those of the panel unit portion 3. The rib 12 may be formed in a shape other than the above sector-shape, for example, an arcuate shape formed by cutting a disk, which centers about the axis X of angular displacement, along two planes including radial lines of the disk. By forming the rib in the arcuate shape, the strength can be increased.

With the embodiment of the invention, there are provided a first sliding member 15 and a second sliding member 23 to slide on the rib 12. The respective sliding members 15, 23 are made elements, which constitute a position holding means 18. A tilting mechanism is constructed to include the position holding means 18 and the rib 12. The position holding means 18 is constructed to comprise the first and second sliding members 15, 23, a compression coil spring 16 for applying a spring force to the first sliding member 15, and an energizing casing 17, which receives the first sliding member 15 and the compression coil spring 16.

The energizing casing 17 is formed to have an external form of substantially rectangular parallelopiped to receive the first sliding member 15 and the compression coil spring 16. The energizing casing 17 is fixed to the upper cabinet 2b and provided with an opening, which faces and opens to the rib 12. The first sliding member 15 is guided by the energizing casing 17 to be able to be displaced in the axial direction B, and the first sliding member 15 received in the energizing casing 17 projects from the opening of the energizing casing 17, which faces the rib 12, to come into surface contact with the rib 12. The rib 12 and the first sliding member 15 contact each other in a different position from the base end 3a of the panel unit portion 3, in particular, in a position distant from the axis X of angular displacement in a radial direction C. Also, the rib 12 and the first sliding member 15 come into surface contact with each other in all angular positions in an angular range, in which the panel unit portion 3 is able to make angular displacement.

The energizing casing 17 comprises a bottom wall portion disposed on the upper cabinet 2b, a pair of side wall portions 19, 20 provided upright from the bottom wall portion to extend in the axial direction B, a cover wall portion 22 contiguous to the pair of side wall portions 19, 20 and disposed to be opposed to and in parallel to the bottom wall portion, and an end wall portion 21 provided upright from the bottom wall portion to be contiguous to ends of the pair of side wall portions opposed to the rib, the respective wall portions being formed in a plate shape. The side wall portions 19, 20, as shown in FIG. 3, may be provided with guide portions 19a, 20a, which project inside the energizing casing from the side wall portions 19, 20 to smoothly guide the first sliding member 15 toward the rib 12. Whereby the first sliding member 15 is guided without play in the axial direction B.

The compression coil spring 16 constitutes a spring force generating portion for applying a spring force to the first sliding member 15 in the axial direction B, and applies a greater spring force to the first sliding member 15 as the first sliding member 15 is disposed upstream in a pressing direction. Concretely, the compression coil spring 16 is received in the energizing casing 17 in a state of being compressed from a natural state to be coaxial with the axial direction B with one end 16a thereof in contact with the first sliding member 15 and the other end 16b thereof in contact with the end wall portion 21 of the energizing casing 17. The compression coil spring 16 elastically presses the first sliding member 15 toward the rib 12 in the axial direction B with a restoring force. In this manner, the compression coil spring 16 is used as a spring force generating portion whereby a spring force is hard to be varied under the influences of that dimensional change in the axial direction B, which is caused by wear of the rib 12 and the first sliding member 15, and the first sliding member 15 can be stably pressed.

The first sliding member 15 comprises a rectangular column portion 24 formed in a substantially rectangular-column shape, and a shaft portion 25 projecting from the rectangular column portion 24 in the axial direction B. The shaft portion 25 is formed in a circular-cylinder shape to have an outer peripheral diameter smaller than an inner peripheral diameter of the compression coil spring 16. The first sliding member 15 is received in the energizing casing 17 with the shaft portion 25 inserted into the compression coil spring 16, the rectangular column portion 24 facing the rib 12, and the shaft portion 25 extending in the axial direction B. The compression coil spring 16 abuts against an end surface of the rectangular column portion 24 opposed to the rib 12. A tip end of the shaft portion 25 is inserted through an insertion hole 21a provided on the end wall portion 21 to project from the energizing casing 17. The rectangular column portion 24 of the first sliding member 15 is disposed in a space surrounded by the bottom wall portion, the two side wall portions 19, 20, and the cover wall portion 22. Thus any large displacement in other directions than the axial direction is prevented.

Also, a pressing force changing portion may be provided to adjust a spring force applied on the first sliding member 15 by the compression coil spring 16, so, for example, a thread portion provided with male threads may be formed on the shaft portion 25. A nut is screwed onto the thread portion to thereby adjust a position, in which one end 16a of the compression coil spring 16 abuts, whereby a spring force, with which the compression coil spring 16 presses the first sliding member 15, can be changed. With such pressing force changing portion, a pressing force, with which the first sliding member 15 biases the rib 12, may be adjusted.

The cover wall portion 22 is formed on the respective side wall portions 19, 20 partially toward the rib 12 in the axial direction B. Accordingly, portions of the respective side wall portions 19, 20 opposed to the rib in the axial direction B are opened toward the panel unit portion 3 and formed so that an operator can visually see the compression coil spring 16 and the first sliding member 15, which are received in the energizing casing 17.

With the embodiment, there is further provided the second sliding member 23 different from the first sliding member 15. The second sliding member 23 is arranged to be opposed to the first sliding member 15 with the rib 12 therebetween in the axial direction B. For example, the second sliding member 23 is fixed to the upper cabinet 2b to be arranged in a state of being close to or in surface contact with the rib 12. When the first sliding member 15 presses the rib 12 in the axial direction B, the first and second sliding members 15, 23 cooperate to sandwich the rib 12 therebetween in the axial direction B.

Surfaces of those slide portions 15a, 23a of the first and second sliding members 15, 23, which slide on the rib 12, are formed to be substantially planar. Slide portions 12a, 12b of the rib 12, which slide on the first and second sliding members 15, 23, are provided on both sides in the axial direction, and surfaces of the slide portions are formed to be substantially planar. The rib 12, and the slide portions 15a, 23a of the first and second sliding members 15, 23 have planar surfaces thereof coming into surface contact with each other.

The slide portions 12a, 12b of the rib 12 extend circumferentially to have a larger area than that of the surfaces of the slide portions 15a, 23a of the respective sliding members 15, 23. Also, the slide portions 15a, 23a of the respective sliding members 15, 23 are formed from a material having a greater coefficient of friction with the slide portions 12a, 12b of the rib 12 than that of the remaining sliding member bodies. The slide portions 15a, 23a are implemented by bonding a thin sheet-shaped material to the sliding member bodies as by an adhesive. Used as the material is a sheet-shaped rubber, into which powder of cork is mixed. With the respective sliding members 15, 23 in the embodiment, the slide portions 15a, 23a thereof are implemented by a material, which possesses a high coefficient of friction at the time of contact, flexibility and elasticity, and the body portions except the slide portions are implemented by a material, which possesses a higher rigidity than that of the slide portions 15a, 23a. At least the slide portions 15a, 23a are set to have a coefficient of friction, with which frictional forces capable of preventing angular displacement of the panel unit portion 3 caused due to its own weight are obtained.

Also, the upper cabinet 2b is formed with a reception recess 28, which receives the rib 12. The reception recess 28 is provided in a position to face the rib 12, and formed by cutting out the upper cabinet 2b in a direction perpendicular to the axis X of angular displacement. The upper cabinet 2b is provided so that the reception recess 28 prevents the upper cabinet 2b from impeding angular displacement of the rib 12 while the panel unit portion 3 is moved in the closing direction A2. Also, the panel unit portion 3 is preferably formed with a recess or a projection, on which an operator's fingers hold, whereby an operator holds his hand on the recess or the projection to be able to apply an external force for angular displacement.

With the above arrangement, a tilting mechanism is configured such that an operator holds his fingers on the tip end 3b of the panel unit portion 3 to apply an external force on the panel unit portion 3 in the circumferential direction A about the axis of angular displacement whereby the panel unit portion 3 makes angular displacement to be held in an angular position desired by the operator.

As shown in FIG. 2, the compression coil spring 16 received in the energizing casing 17 elastically generates spring forces on the both ends thereof in a try to be returned to a natural state. Since the other end 16b of the compression coil spring 16 is prevented by the end wall portion 21 of the energizing casing 17 from displacement, the compression coil spring 16 applies a spring force on the rectangular column portion 24 of the first sliding member 15, which abuts against the one end 16a of the spring, in the axial direction B. Since the compression coil spring 16 is deformed in a state, in which the shaft portion 25 is inserted radially inward into the spring, at this time, it abuts against the shaft portion 25 to be prevented from getting out of the shaft portion 25 even when it is deformed in other directions than the axial direction B.

The first sliding member 15 having been given a spring force by the compression coil spring 16 projects toward the rib 12 from the opening of the energizing casing 17 on a side of the rib to elastically come into surface contact with the rib 12. When the rib 12 is pressed by the first sliding member 15 in one sense of the axial direction, it presses the second sliding member 23 in the one sense of the axial direction. At this time, the rib 12 is acted by that reaction force, which is equivalent to a force applied on the second sliding member 23, from the second sliding member 23. Thereby, the rib 12 is pressed in both senses of the axial direction by the first and second sliding members 15, 23. Since pressing the first sliding member 15 results in bringing the first and second sliding members 15, 23 into surface contact with the rib 12, great friction forces are generated as compared with the case with only the first sliding member 15.

The rib 12 pressed on both sides thereof is exerted on normal forces, which act in a direction perpendicular to the sides thereof. Since these normal forces are given by the compression coil spring 16, they assume the same values provided that the first sliding member 15 is fixed in position, irrespective of a position of angular displacement of the panel unit portion 3 and gravity of the panel unit portion 3.

Since the first sliding member 15 is fixed to the upper cabinet 2b through the energizing casing 17 and the second sliding member 23 is fixed to the upper cabinet 2b, contact regions, in which the rib 12 is put in surface contact with the respective sliding members 15, 23, change as the rib 12 makes angular displacement relative to the upper cabinet 2b about the axis of angular displacement. For example, in the case where the rib 12 contacts with the respective sliding members 15, 23 toward the other end 14 of the rib in the circumferential direction as shown in FIG. 2, contact regions change toward the one end 13 of the rib 12 in the circumferential direction when the rib 12 makes angular displacement in the closing direction A2. In other words, the rib 12 and the respective sliding members 15, 23 slide relative to each other and the slide position of the rib 12 changes.

The own weight of the panel unit portion 3 exerts an external force of angular displacement on the rib 12 in the closing direction A2. When being exerted by an external force of angular displacement, the rib 12 is exerted by the normal forces from the first and second sliding members 15, 23, so that it is acted by frictional forces in a direction, in which angular displacement is impeded. Magnitude of the maximum static frictional forces at this time is determined by products of coefficient of friction between the rib 12 and the respective sliding members 15, 23, and the pressing forces, with which the respective sliding members 15, 23 press the rib 12, in other words, the normal forces. The maximum static frictional forces acting when standstill are set to be greater than the external force of angular displacement applied by the own weight of the panel unit portion 3, whereby the rib 12 is prevented from making angular displacement. Thereby, angular displacement of the panel unit portion 3 contiguous to the rib 12 is impeded. Accordingly, the first and second sliding members 15, 23 press the rib 12 to thereby prevent angular displacement caused by the own weight of the panel unit portion 3.

In the case where an external force of angular displacement exceeding maximum static frictional forces is given by an operator, the rib 12 is allowed to make angular displacement and the external force causes the panel unit portion 3 to make angular displacement. Also, the operator removes the external force of angular displacement in a state, in which the panel unit portion 3 is disposed in a position of angular displacement desired by the operator, whereby the panel unit portion 3 is acted only by an external force of angular displacement caused by the own weight of the panel unit portion and so prevented from angular displacement to be held in the position in the state, that is, the position of angular displacement desired by the operator.

As described above, according to the embodiment of the invention, a tilting mechanism can be configured, in which frictional forces are given to the rib 12 to thereby prevent angular displacement of the panel unit portion 3 caused by the own weight thereof, the panel unit portion 3 is allowed to make angular displacement when an external force of angular displacement is given by an operator, and the panel unit portion 3 is held in a position of angular displacement desired by the operator.

Also, the respective sliding members 15, 23 come into surface contact with the sides of the rib 12 to thereby reduce an amount of wear of the rib 12.

Further, when the rib 12 has made angular displacement, its position relative to the respective sliding members 15, 23 changes and so contact regions of the rib 12, in which it comes into surface contact with the respective sliding members 15, 23, change in the circumferential direction. The rib 12 moves in a state, in which the rib 12 and the respective sliding members 15, 23 come into surface contact with each other, whereby contact regions of the rib 12 also change in the circumferential direction. Thereby, the rib 12 and the respective sliding members 15, 23 can be caused to slide in a wide range. In this manner, since the respective sliding members 15, 23 slide in a region of wide range on the rib 12, an amount of wear of the rib 12 at the time of angular displacement can be further reduced. In this manner, the rib slides in a wide range in a state of surface contact, whereby an amount is reduced, in which the rib 12 wears and is shaved in the axial direction B.

Thereby, even in the case where angular displacement of the panel unit portion 3 has been repeated over a long term, reduction in coefficient of friction and frictional force can be prevented. Also, even if the rib 12 had worn, surface contact could keep frictional forces between the rib 12 and the respective sliding members 15, 23 in a predetermined range. Thereby, an appropriate holding force can be obtained over a long term, and a particularly favorable application can be found in apparatuses, in which the panel unit portion 3 makes angular displacement in a high frequency of use. Also, even in the case where the panel unit portion 3 is large in weight and pressing forces, with which the respective sliding members 15, 23 press the rib 12, are set to be large in order to prevent angular displacement of the panel unit portion 3 caused by the own weight thereof, it is possible to prevent reduction, caused by wear, in friction forces and maintain a holding force, with which the panel unit portion 3 is surely held in an optional angular position.

Also, since the slide portions 15a, 23a of the first and second sliding members 15, 23 are formed from a material having flexibility and elasticity, the slide portions 15a, 23a are deformed to prevent local contact to be able to maintain a state of surface contact between the rib 12 and the sliding member 15 even when contact surfaces of the rib 12 and the sliding members 15, 23 are pressed in a nonuniform load distribution.

Also, since the both sides of the rib 12 and the respective sliding members 15, 23 contact with each other at substantially planar surfaces, easy and sure surface contact can be achieved as compared with the case where curved surfaces contact with each other. Also, the both sides of the rib 12 and surfaces of the respective sliding members 15, 23 are formed to be planar, whereby it is possible to achieve correct and easy bonding of sheet-shaped rubber, which forms the slide portions 15a, 23a of the respective sliding members 15, 23. Further, the remaining portions of the slide portions 15a, 23a are formed from a material having a higher rigidity than that of the slide portions 15a, 23a, so that the remaining portions undergo less deformation due to the spring force of the compression coil spring 16 to be able to apply favorable pressing forces to the rib 12.

The rib 12 is formed to project from a position of the panel unit portion 3 radially distant from the axis X of angular displacement whereby frictional forces can be applied to a position of the panel unit portion 3 radially distant from the axis X of angular displacement. While the panel unit portion 3 is acted by an overturning moment, which is generated by an external force tending to cause angular displacement about the axis X of angular displacement due to the own weight thereof, a resisting moment acting in a direction opposed to the overturning moment acts owing to frictional forces. The overturning moment and the resisting moment are equalized with each other to thereby prevent angular displacement of the panel unit portion 3. The more radially distant from the axis X of angular displacement the given friction forces, the greater the resisting moment. Accordingly, even when the panel unit portion 3 has a large own weight, a position, in which frictional forces are applied, is adjusted to enable increasing the resisting moment without increasing a pressing force, with which the first sliding member 15 presses the rib 12, and so an appropriate holding force can be obtained in a simple construction without large-sizing of construction.

Also, the rib 12 has an arcuate, outer peripheral surface centering about the axis X of angular displacement to thereby reduce an exclusive region required for angular displacement of the rib 12. Thereby, it is possible to make the telephone 1 small in size.

Also, an external force of angular displacement for opening and closing of the panel unit portion 3 acts on the rotary bearings 6a, 6b, which constitute two shaft supporting portions installed on the base end 3a of the panel unit portion 3, through the rib 12. Since the rib 12 is mounted in a central portion of a dimension between the two rotary bearings provided on the panel unit portion 3 in the axial direction B, forces acting on the two rotary bearings 6a, 6b, and their senses become symmetrical to enable preventing any twisting forces from acting on the panel unit portion 3 when an external force of angular displacement is applied. Also, it is possible to make movements of the panel unit portion 3 smooth and to prevent an increase in wear of moving portions, thus enabling enhancing durability of the rotary bearings 6a, 6b.

Further, the two sliding members 15, 23 press the rib 12 from both sides in the axial direction, whereby it is possible to prevent deformation of the rib 12 even in the case where the spring force of the compression coil spring 16 is increased. Thereby, it is possible to prevent breakage of the rib 12 even in the case where the panel unit portion 3 becomes large in size and the spring force is increased in order to increase frictional forces for prevention of angular displacement of the panel unit portion 3 due to the own weight thereof.

Since the radially outward portion of the rib 12 is formed to be small in axial dimension as compared with the radially inward portion thereof, the rib can be guided to a position opposed to the respective sliding members 15, 23 in a state, in which gaps are present between the rib 12 and the respective sliding members 15, 23, so that positioning of the rib 12 and the respective sliding members in a predetermined position can be easily achieved. Thereafter, the radially inward portion of the rib 12 is caused to approach the respective sliding members 15, 23 whereby gaps between the respective sliding members 15, 23 and the rib 12 are removed to enable elastically bringing the respective sliding members 15, 23 into surface contact with the rib 12. In this manner, the rib 12 can be easily arranged in a predetermined position to perform the assembling work of an electronic apparatus with ease.

The above configuration is only exemplary of the invention and can be modified within a scope of the invention. For example, a telephone having the facsimile function is exemplified but the invention may be applied also to other electronic apparatuses than telephones. For example, the invention may be applied to a note personal computer having a display portion and a panel capable of angular displacement, and portable type information-processing apparatuses such as portable telephones. Also, while the panel unit portion 3 having the display portion 4 is used as the tilting portion, the above tilting mechanism may be used for angular displacement portions other than the panel unit portion. The tilting mechanism may be used for, for example, an angular displacement portion of the sheet feeding portion 10 provided on an electronic apparatus. Use of the above tilting mechanism for the sheet feeding portion 10 affords angular displacement between a movable position, in which sheets are received, and a non-movable position, in which sheets are not received. Even when sheets received in the sheet feeding portion 10 are increased in number, the sheet feeding portion 10 makes no angular displacement due to the weight of sheets and can be appropriately used.

Also, while a sheet-shaped rubber having a high coefficient of friction is bonded to the slide portions 15a, 23a of the first and second sliding members 15, 23, the invention is not limited thereto but a sheet-shaped rubber may be bonded to the slide portions 12a, 12b of the rib 12, which slides on the first and second sliding members 15, 23, to provide a configuration with a high coefficient of friction and no sheet-shaped rubber may be bonded to the first and second sliding members 15, 23. Also, both the slide portions 12a, 12b and 15a, 23a of the rib 12 and the respective sliding members 15, 23 may be configured to provide for high coefficients of friction. In this manner, the respective slide portions are adjusted in shape and material conformed to a necessary holding force.

Also, instead of acquiring high coefficient of friction attributable to bonding of a sheet-shaped rubber, surfaces of the respective slide portions 12a, 12b and 15a, 23a may be roughened to enable making coefficient of friction high. For example, when being formed in the molding processing, roughened surfaces are beforehand formed on portions of a metallic die corresponding to the slide portions 12a, 12b and 15a, 23a to enable roughening the slide portions of the rib 12 and the respective sliding members 15, 23 as molded. Also, a wire brush, or the like may be used to roughen the slide portions after the molding. In this manner, the slide portions are roughened to be specifically suited to electronic apparatuses, in which frequency of angular displacement is small.

Also, for example, a mount position on an electronic apparatus, and an axial dimension and a material of the rib 12 are appropriately selected to prevent deformation of the rib 12, thereby enabling omitting the second sliding member 23, and thus the effect of the invention can be obtained only with the first sliding member 15. Omission of the second sliding member 23 makes it possible to further reduce constituent parts, and a particularly application to small-sized apparatuses, in which space saving is important, is made possible. Also, the first sliding member 15 may come into surface contact not with a side of the rib 12 but a peripheral surface of the rib 12.

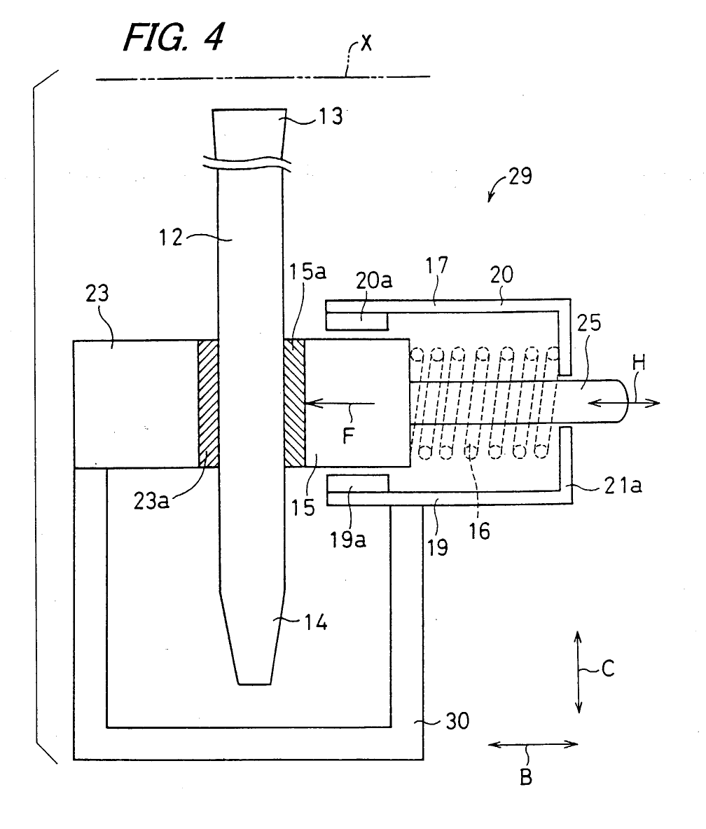

FIG. 4 is a cross sectional view showing an essential part of a telephone according to a further embodiment of the invention. The telephone shown in FIG. 4 comprises position holding means 29 different from that of the telephone 1 described above, and is the same as the telephone 1 in other configuration, an explanation for the same configuration being omitted and the same reference numerals being used to denote the configuration.

The position holding means 29 further comprises a holding member 30 to connect the second sliding member 23 and the energizing casing 17 to each other. The holding member 30 is formed in a substantially U-shape convexly outward in a radial direction C to connect the side wall portion 19 of the energizing casing outward in the radial direction C relative to the axis X of angular displacement and a portion of the second sliding member 23 outward in the radial direction C to each other. Thereby, the position holding means 29 is configured integrally with the energizing casing 17 and the second sliding member 23 as a unit. When a telephone is to be assembled, it suffices to arrange a unit integrated with the energizing casing 17 and the second sliding member 23, and relative positioning of the second sliding member 23 and the energizing casing 17 is unnecessary, thus enabling the assembly with ease. Also, since assembly can be made in a state, in which relative positioning of the second sliding member 23 and the energizing casing 17 is kept, adjustment is easy and high in accuracy and maintenance after assembly can also be easily carried out. Also, the same constitution as that of the telephone 1 shown in FIG. 1 can take the same effect.

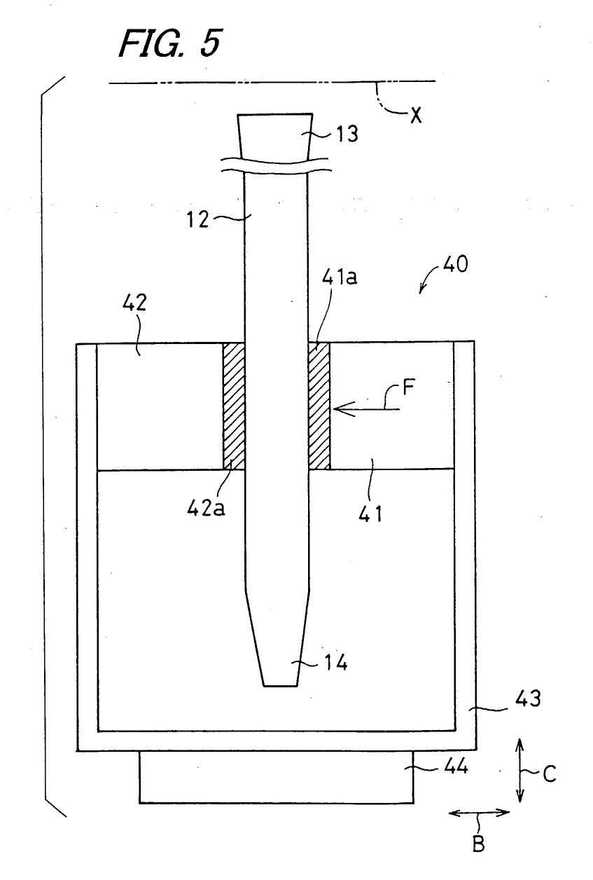

FIG. 5 is a cross sectional view showing an essential part of a telephone according to a still further embodiment of the invention. The telephone shown in FIG. 5 comprises position holding means 40 different from that of the telephone 1 described above, and is the same as the telephone 1 in other configuration, an explanation for the same configuration being omitted and the same reference numerals being used to denote the configuration.

The position holding means 40 comprises a first sliding member 41, a second sliding member 42, a holding member 43 to connect the first sliding member 41 and the second sliding member 42 to each other, and an energizing base 44 fixed to the upper cabinet 2b. The holding member 43 is formed to be substantially U-shaped, and provided on both ends thereof with the first sliding member 41 and the second sliding member 42. The holding member 43 has flexibility and elasticity, so that the first and second sliding members 41, 42 are provided to be able to make elastic displacement. The holding member 43 is arranged to bridge across the rib 12, and both ends of the rib 12 in an axial direction are opposed to the first and second sliding members 41, 42, respectively. A distance between the first and second sliding members 41, 42 in a natural state is made smaller than an axial dimension of the rib 12, and so the first and second sliding members 41, 42 arranged in a position opposed to the rib 12 are given a spring force by the holding member 43 to elastically press the rib 12 from opposite sides. Slide portions 41a, 42a are provided on those areas of the first and second sliding members 41, 42, which abut against the rib 12, the slide portions 41a, 42a being formed from a material, for example, a sheet-shaped rubber, having a higher coefficient of friction than that of the slide portion bodies. The energizing base 44 is fixed approximately centrally of the holding member 43 and fixed to the upper cabinet 2b.

In this manner, the holding member 43 gives a spring force to the first and second sliding members 41, 42, so that there is no need of the energizing casing 17 and the compression coil spring 16 a contrast to the position holding means 18 shown in FIG. 1, thereby enabling simplifying the constitution. Thereby, such arrangement is suited to simple electronic apparatuses provided with a small-sized and lightweight panel unit portion 3.

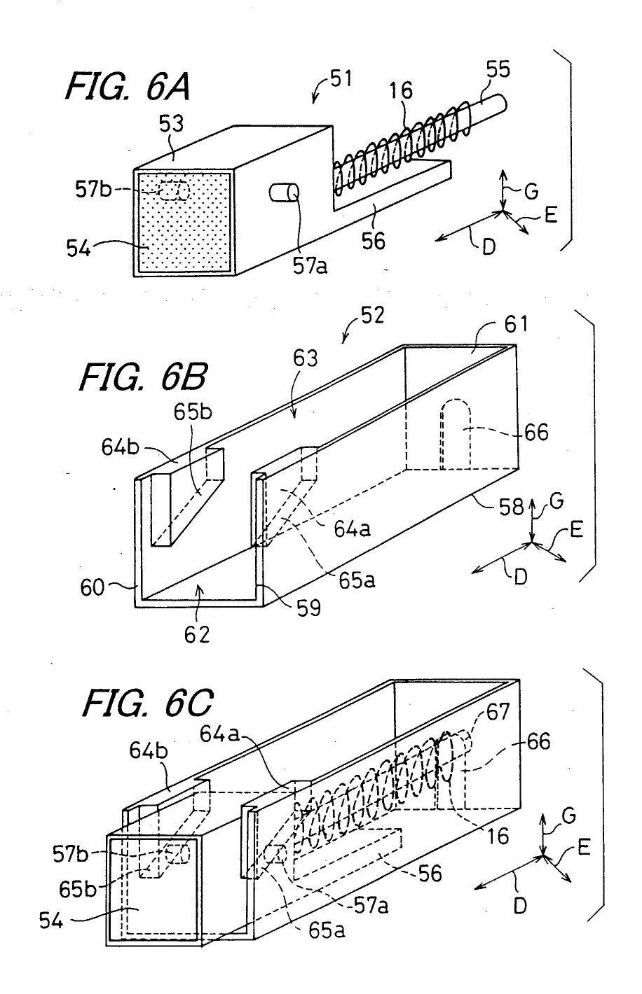

FIGS. 6A to 6C are perspective views showing a first sliding member 51 and an energizing casing 52 of a telephone according to a further embodiment of the invention. The telephone shown in FIGS. 6A to 6C is the same as the telephone 1 described above except the first sliding member 51 and the energizing casing 52, so an explanation for the same configuration is omitted, the same reference numerals being used to denote the configuration. As shown in FIGS. 6A to 6C, there are assumed a first direction D, a second direction E perpendicular to the first direction D, and a third direction G perpendicular to both the first and second directions D, E. The first sliding member 51 comprises a body 53 in the form of a square column, a slide portion 54 provided on one end of the body 53 in the first direction to slide on the rib 12, a shaft portion 55 projecting from the other end of the body 53 in the first direction to extend in the first direction D, a bottom plate portion 56 projecting from the other end of the body 53 in the first direction to extend in the first direction D, and a pair of guide pins 57a, 57b projecting from both opposing sides of the first sliding member 51 in the second direction to extend in the second direction E. The body 53 comprises respective first direction end surfaces provided upright on a pair of side edges of a rectangular bottom surface to be opposed to each other and align in the first direction D, and respective second direction end surfaces provided upright on a pair of other side edges of the bottom surface to be opposed to each other and align in the second direction E.

The slide portion 54 is provided at the one end of the body 53 in the first direction, and, for example, a sheet-shaped rubber having a high coefficient of friction against the rib 12 is bonded to the slide portion. The bottom plate portion 56 projects from the other end of the body 53 in the first direction to extend perpendicular to the other end surface in the first direction. Also, the bottom plate portion 56 comprises a bottom surface flush with the bottom surface of the body 53, and side surfaces flush with the pair of second direction side surfaces of the body 53. A dimension, in other words, a dimension in a height direction, from the bottom surface of the bottom plate portion 56 to a surface opposed to the bottom surface in the third direction is smaller than a heightwise dimension of the body 53.

The shaft portion 55 comprises a columnar shaft to project perpendicularly from a position centrally on the first direction other end surface of the body 53 in the second direction E and in the third direction G to extend in the first direction D. The shaft portion 55 is inserted through an inner peripheral space of the compression coil spring 16 to be arranged coaxial with the compression coil spring 16. The respective guide pins 57a, 57b serve as guides for the sliding member, and is formed to be columnar-shaped, the guide pins projecting perpendicularly from substantially central positions on the respective second direction side surfaces of the body 53 in opposite directions.

The energizing casing 52 is formed to be able to receive therein the first sliding member 51, and has an outward appearance in the form of a substantially rectangular parallelopiped. The energizing casing 52 comprises a bottom wall portion 58 in the form of a rectangular plate, a pair of side wall portions 59, 60 and an end wall portion 61, respectively, projecting perpendicularly from three side edges of the bottom wall portion 58. Openings 62, 63 are provided on the energizing casing 52 in the first direction D and in the third direction G, respectively, in a state, in which the first sliding member 51 is received in the energizing casing.

The pair of side wall portions 59, 60 are provided with fixed guides 64a, 64b, respectively, against which the guide pins 57a, 57b of the first sliding member 51 abut in a state, in which the first sliding member 51 is received in the energizing casing. One 64a of the fixed guides is provided on one 59 of the side wall portions to project from the one 59 of the side wall portions toward the other 60 of the side wall portions. Likewise, the other 64b of the fixed guides projects from the other 60 of the side wall portions toward the one 59 of the side wall portions. The respective fixed guides 64a, 64b are opposed to each other, and have inclined surfaces 65a, 65b, which are inclined toward the opening 63 formed in the third direction G as surfaces facing the bottom wall portion 58 of the energizing casing 52 go in the first direction, in other words, toward the end wall portion 61.

Also, the end wall portion 61 is formed with an insertion hole 66, which permits the shaft portion 55 to be inserted through the end wall portion 61 in a state, in which the first sliding member 51 is received. The insertion hole 66 is provided as an elongate hole to extend through the end wall portion 61 in the third direction G.

In a state, in which the first sliding member 51 is received in the energizing casing 52, the shaft portion 55 is inserted through the compression coil spring 16 with its tip end 67 projecting outside the energizing casing from the insertion hole 66. The insertion hole 66 is formed to be smaller than the outer peripheral diameter of the compression coil spring, and the compression coil spring 16 is received in the energizing casing 52. The compression coil spring 16 is received in the energizing casing 52 in a state of being compressed from a natural state, and applies a restoring force to press the end wall portion 61 of the casing 52 and the body 53 in opposite directions. The first sliding member 51 is pressed in one sense of the first direction D to be spaced away from the end wall portion 61 of the casing 52, and the guide pins 57a, 57b of the first sliding member 51 elastically abut against the inclined surfaces 65a, 65b of the fixed guides 64a, 64b. At this time, the slide portion 54 of the first sliding member 51 projects from the opening 62 of the energizing casing 52 in the first direction D. Also, the energizing casing 52 has a storage space, which permits the first sliding member 51 received to move in the first direction D and to move slightly in the third direction G. Since bottom surfaces of the body and the bottom plate portion 56 are formed to be flush with each other, the bottom surface of the first sliding member 51 contacts with the bottom wall portion 58 of the energizing casing to be able to be stably displaced in the first direction D.

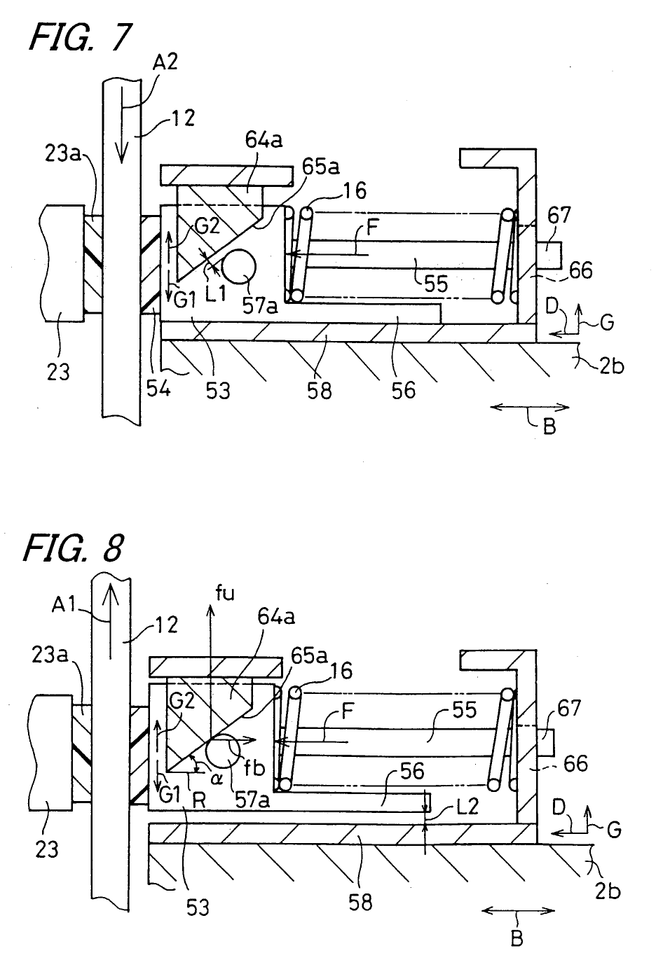

FIGS. 7 and 8 are cross sectional views showing in enlarged scale states, in which the first sliding member 51 is received in the energizing casing 52, FIG. 7 showing a state, in which the rib 12 is stationary, and FIG. 8 showing a state, in which the rib 12 is moved in the opening direction A1. The energizing casing 52 and the first sliding member 51 are arranged with the first direction D in parallel to the axis X of angular displacement, that is, in the axial direction B, so that the opening 62 in the first direction D faces the rib 12. Also, the second direction E and the third direction G are positioned to be perpendicular to the axis X of angular displacement, the third direction G being positioned to be perpendicular to the upper cabinet 2b. Also, the energizing casing 52 is fixed to the upper cabinet 2b with the bottom wall portion 58 abutting against the upper cabinet 2b. In a state, in which the energizing casing 52 is mounted on the telephone 1, one sense G1 of the third direction coincides with the closing direction A2 and the other sense G2 of the third direction coincides with the opening direction A1.

In a state, in which the rib 12 is stationary, the first sliding member 51 is given a spring force by the compression coil spring 16. As shown in FIG. 7, the slide portion 54 elastically presses the rib 12, and the first sliding member 51 is pushed back by the rib 12 in the axial direction B to release contact between the respective guide pins 57a, 57b and the fixed guides 64a, 64b.

An external force of angular displacement in the closing direction A2 is exerted on the rib 12 by the own weight of the panel unit portion 3. At this time, since the first sliding member 51 presses the rib 12, it is given an external force to be moved in the same direction as the rib 12 does. That is, the first sliding member is exerted by an external force toward the upper cabinet 2b, in other words, in one sense G1 of the third direction. A gap allowing a slight movement in the third direction G is provided between the first sliding member 51 and the energizing casing 52 whereby the first sliding member 51 together with the rib 12 is displaced toward the upper cabinet 2b and its bottom surface abuts against the bottom wall portion 58 of the energizing casing 52. Having abutted against the bottom wall portion 58, the first sliding member 51 is inhibited from further displacement in one sense G1 of the third direction.

Owing to the own weight of the panel unit portion 3, the rib 12 applies an external force in one sense G1 of the third direction on the first sliding member 51, which has been inhibited from displacement in one sense G1 of the third direction. Thereby, produced between the rib 12 and the first sliding member 51 is a frictional force in the other sense G2 of the third direction. The external force caused by the own weight of the panel unit portion 3 in one sense G1 of the third direction becomes equal to the frictional force in the other sense G2 of the third direction to thereby inhibit angular displacement of the rib 12, so that the panel unit portion 3 makes no angular displacement in spite of its own weight and is maintained in an optional angular position.

At this time, the bottom wall portion 58 of the energizing casing 52 and the first sliding member 51 are put in a state to abut against each other, and there is generated a guide in-between clearance L1 between the guide pins 57a, 57b and the inclined surfaces 65a, 65b of the fixed guides 64a, 64b. The guide pins 57a, 57b and the inclined surfaces 65a, 65b do not abut against each other and the first sliding member 51 presses the rib 12, whereby a spring force of the compression coil spring 16 acts as a pressing force of the first sliding member 51.

Also, even in the case where the panel unit portion 3 is to be moved in the closing direction A2, the rib 12 is moved in the closing direction A2 whereby the first sliding member 51 is moved in the same direction as the rib 12 does, and an external force acts in one sense G1 of the third direction perpendicular to the upper cabinet 2b. In the same manner as shown in FIG. 7, the first sliding member 51 together with the rib 12 is displaced toward the upper cabinet 2b to abut against the bottom wall portion 58 of the energizing casing 52, and there is generated a guide in-between clearance L1 between the inclined surfaces 65a, 65b and the guide pins 57a, 57b. Thereby, being not impeded by the guides, a spring force of the compression coil spring 16 acts as a pressing force of the first sliding member 51 as it is. An external force given by an operator to direct the panel unit portion 3 in one sense G1 of the third direction becomes larger than a frictional force in the other sense G2 of the third direction whereby angular displacement of the rib 12 is allowed and the panel unit portion 3 makes angular displacement in the closing direction.

At this time, the bottom wall portion 58 of the energizing casing 52 and the first sliding member 51 are put in a state to abut against each other in the same manner as described above, and there is generated a guide in-between clearance L1 between the guide pins 57a, 57b and the inclined surfaces 65a, 65b of the fixed guides 64a, 64b, so that a spring force of the compression coil spring 16 acts on the rib 12 as a pressing force of the first sliding member 51 as it is.

Also, in the case where the rib 12 is moved in the opening direction A1 as shown in FIG. 8, an external force tending to move the first sliding member in the same direction as the rib 12 does is produced since the first sliding member 51 presses the rib 12, so that an external force is produced in the other sense G2 of the third direction away from the upper cabinet 2b. The first sliding member 51 together with the rib 12 is displaced in the other sense G2 of the third direction away from the upper cabinet 2b and the guide pins 57a, 57b abut against the inclined surfaces 65a, 65b of the fixed guides 64a, 64b. Having abutted against the fixed guides 64a, 64b, the first sliding member 51 is prevented from being further displaced in the other sense G2 of the third direction.

An external force acting in the other sense G2 of the third direction is exerted on the first sliding member 51, which has been prevented from being displaced in the other sense G2 of the third direction, by the rib 12, whereby a frictional force acting in one sense G1 of the third direction is produced between the rib 12 and the first sliding member 51. An external force given by an operator to direct the panel unit portion 3 in the other sense G2 of the third direction becomes larger than a frictional force acting in one sense G1 of the third direction whereby the panel unit portion 3 makes displacement in the opening direction A1.

At this time, the inclined surfaces 65a, 65b of the fixed guides 64a, 64b of the energizing casing 52 and the guide pins 57a, 57b of the first sliding member 51 are put in a state to abut against each other, and there is generated a slide-member in-between clearance L2 between the bottom wall portion 58 of the energizing casing 52 and the bottom surface of the first sliding member 51. In a state, in which the guide pins 57a, 57b and the inclined surfaces 65a, 65b abut against each other, the first sliding member 51 presses the rib 12 whereby a spring force of the compression coil spring 16 causes the first sliding member 51 to press the rib 12 and the inclined surfaces 65a, 65b. Thereby, the first sliding member 51 divides a spring force of the compression coil spring 16 into two component forces, one of which is exerted on the rib 12 and the other of which is exerted on the fixed guides 64a, 64b.

Concretely, angular displacement of the rib 12 in the opening direction causes the first sliding member 51 to be acted by that force, which tends to displace the first sliding member 51 in the other sense G2 of the third direction, whereby the first sliding member 51 applies on the fixed guides 64a, 64b a force fu, with which the inclined surfaces 65a, 65b as shown in FIG. 8 are pressed in the other sense G2 of the third direction. The force fu exerted on the fixed guides 64a, 64b is given by fu=μFa. Here, fu denotes a force, with which the fixed guides 64a, 64b are pressed, μ denotes a coefficient of friction between the rib 12 and the slide portion 54, and Fa denotes a force in proportion to a force F, with which the compression coil spring 16 presses the first sliding member 51. While Fa is somewhat smaller than F, it may be assumed to be approximately F. Also, where α denotes an angle of inclination between the inclined surfaces 65a, 65b and an imaginary line R extending in the first direction D and fb denotes a reactive pressing force given to the guide pins 57a, 57b by the fixed guides 64a, 64b and acting in a horizontal direction which is given by the force fu, with which the inclined surfaces 65a, 65b are pressed in the other sense of the circumferential direction, fb meets the following formula.

$$f b = \frac{μ tan α}{( 1 + μ tan α )} \cdot F a$$

Here, since fb acts in a reverse direction to that, in which F acts, Fb meets the following formula where Fb denotes a pressing force, with which the first sliding member 51 presses the rib 12.

$$\begin{matrix}F b = F - \frac{μ tan α}{( 1 + μ tan α )} \cdot F a \\ F ( 1 - \frac{μ tan α}{( 1 + μ tan α )} )\end{matrix}$$

As shown in the above formula, when the rib 12 makes angular displacement in the opening direction A1 and the fixed guides 64a, 64b abut against the guide pins 57a, 57b, that pressing force Fb, with which the first sliding member 51 presses the rib 12, becomes smaller than that force F, with which the compression coil spring 16 presses the first sliding member 51. Also, as shown in FIG. 7, in the case where the rib 12 is made stationary and in the case where the rib 12 is caused to make angular displacement in the closing direction A2, that pressing force Fb, with which the first sliding member 51 presses the rib 12, becomes equal to that force F, with which the compression coil spring 16 presses the first sliding member 51.

That is, that force, with which the first sliding member 51 presses the rib 12 when the panel unit portion 3 is stationary and when the panel unit portion 3 is to be closed, becomes larger than that force, with which the first sliding member 51 presses the rib 12 when the panel unit portion 3 is to be opened. Accordingly, the panel unit portion 3 constituting a tilt action portion can be easily prevented from making angular displacement downward in the closing direction A2 owing to its own weight. Also, a small force can cause the panel unit portion 3 to make angular displacement in the opening direction and thus smoothly make angular displacement.

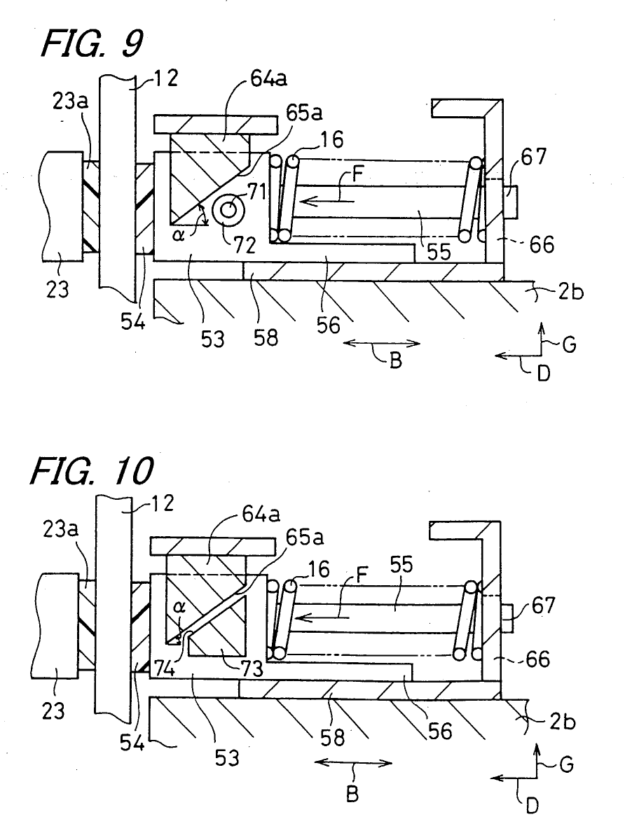

FIG. 9 is a cross sectional view showing an essential part of a telephone according to a further embodiment of the invention. With the telephone shown in FIG. 9, its configuration is different from the first sliding member 51 of the position holding means shown in FIG. 6 but the same in other points. In place of the guide pins as guides for the sliding members, the first sliding member 51 comprises a pair of rotating shafts 71 projecting perpendicularly from both sides of the first sliding member 51, and a pair of roller guides 72 formed on outer peripheries of the rotating shafts 71 to be cylindrical-shaped and rotatable on axes of the rotating shafts 71. When the first sliding member 51 is displaced together with the rib 12 and the roller guides 72 abut against the fixed guides 64a, 64b, the roller guides 72 roll on the inclined surfaces 65a, 65b. Thereby, rolling friction is generated between the roller guides 72 and the fixed guides 64a, 64b whereby frictional forces can be reduced and the panel unit portion 3 can be caused to further smoothly make angular displacement in the opening direction A1.

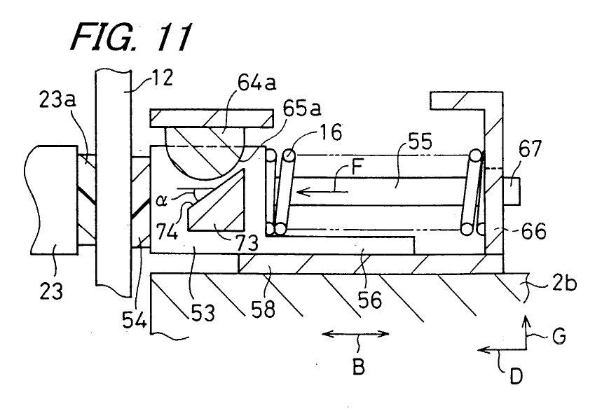

FIG. 10 is a cross sectional view showing position holding means according to a still further embodiment of the invention. With the telephone shown in FIG. 10, its configuration is different from the first sliding member 51 of the position holding means shown in FIG. 6 but the same in other points. In place of the guide pins as guides for the sliding members, a first sliding member 51 comprises sliding-member guides 73 projecting perpendicularly from both sides of the first sliding member 51. The respective sliding-member guides 73 comprise inclined surfaces 74 directed in the other sense G2 of the third direction in the energizing casing 52 as they go in the first direction, that is, toward the end wall portion 61 in a state, in which the first sliding member 51 is received in the energizing casing 52, the inclined surfaces 74 being arranged in parallel to the inclined surfaces 65a, 65b of the energizing casing 52. Thereby, the first sliding member 51 is displaced together with the rib 12 and the inclined surfaces 74 on the sliding-member guides 73 come into surface contact with the inclined surfaces 65a, 65b of the fixed guides 64a, 64b. In this manner, surface contact effected by the two guides 73, 64 enables contact over a wide range and reduction in local wear on the contact surfaces. Also, tape of polyethylene fluoride base fiber, such as polytetrafluoroethylene or the like, for example, Teflon (trade mark), is bonded to the contact surfaces to enable reduction in friction and the panel unit portion 3 to further smoothly make angular displacement in the opening direction A1.

FIG. 11 is a cross sectional view showing a telephone according to a still further embodiment of the invention. With the telephone shown in FIG. 11, its configuration is different from the energizing casing 52 of the telephone 50 shown in FIG. 10 but the same in other points. An energizing casing 52 comprises fixed guides 64a, 64b, which are different in shape from those shown in FIG. 10. In a state, in which the first sliding member 51 is received in the energizing casing 52, inclined surfaces 65a, 65b of the fixed guides 64a, 64b on the energizing casing 52 are formed to define curved surfaces, the inclined surfaces being inclined in the other sense G2 of the third direction as they go in the first direction, that is, toward the end wall portion 61. In this manner, the inclined surfaces 65a, 65b of the fixed guides, which define curved surfaces, contact with the sliding-member guides 73 whereby a coefficient of friction between the sliding-member guides 73 and the fixed guides 64a, 64b can be reduced and the panel unit portion 3 can be caused to smoothly make angular displacement in the opening direction A1.

In FIGS. 6 to 11, the angle α of inclination of the inclined surfaces on one of the fixed guides and the sliding-member guides relative to the axial direction B is set in the range of, for example, from 30 degrees to 60 degrees, which angle α is varied depending upon a holding force for the panel unit portion 3 at the time of opening or closing. Thereby, the panel unit portion 3 can be prevented from making angular displacement due to its own weight and make angular displacement in the opening direction A1 with a small force of angular displacement. In the case where the angle α of inclination is less than 30 degrees, frictional forces generated when the respective guides contact with each other become large, so that angular displacement cannot be made smooth when angular displacement is to be made in the opening direction. Also, in the case where the angle α of inclination exceeds 60 degrees, the reaction forces fb generated on the guides are decreased, so that angular displacement cannot be made smooth when angular displacement is to be made in the opening direction. However, the angle of inclination in the invention is not limited to such range.

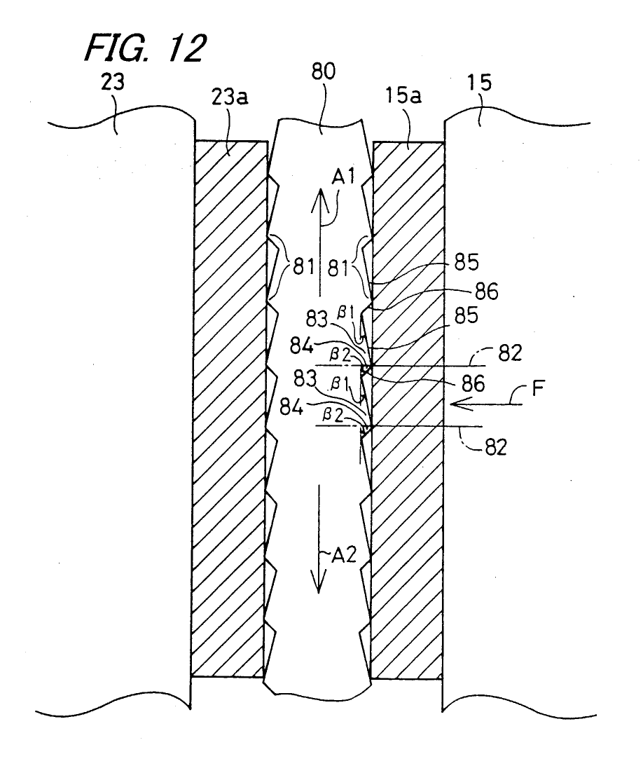

FIG. 12 is a cross sectional view showing a rib 80 according to a further embodiment of the invention. Irregularities may be formed on those slide portions 80a of the rib 80, on which the first and second sliding members 15, 23 slide. Thereby, a coefficient of friction between the first and second sliding members 15, 23 and the rib 80 can be set to be varied according to a direction, in which the rib 80 makes angular displacement. For example, a plurality of projections 81 are formed on the slide portions 80a of the rib 80. The respective projections 81 are formed to be asymmetrical in a circumferential direction. Concretely, the respective projections 81 align in a saw-toothed manner, and are formed such that an opening-direction side portion 83 on one side of the circumferential direction and a closing-direction side portion 84 on the other side of the circumferential direction are asymmetrical with respect to one imaginary plane 82, which extends radially the radial extension of the rib 80 including the axis of angular displacement to pass through an apex of the projection 81. The opening-direction side portion 83 of each projection 81 comprises an inclined surface 85, which is inclined inwardly of the rib as it goes from its apex in the opening direction A1. Also, the closing-direction side portion 84 of each projection 81 comprises an inclined surface 86, which is inclined inwardly of the rib as it goes from its apex in the closing direction A2.

An angle β1 of inclination formed between the inclined surface 85 of the opening-direction side portion 83 and the imaginary plane perpendicular to the axis X of angular displacement is made small as compared with an angle β2 of inclination formed between the inclined surface 86 of the closing-direction side portion 84 and the imaginary plane perpendicular to the axis X of angular displacement.

In the case where the panel unit portion 3 is to make angular displacement, the rib 80 makes angular displacement in the opening direction A1 or in the closing direction A2 in a state, in which the respective slide portions 15a, 23a of the first and second sliding members 15, 23 come elastically into surface contact with the respective projections 81 of the rib 80. In the case where the rib 80 is to make angular displacement in the opening direction A1, the respective slide portions 15a, 23a of the first and second sliding members 15, 23 get over an apex of the projection 81 from the opening-direction side portion 83 of the projection 81 to slide on the closing-direction side portion 84 of the projection 81. Also, in the case where the rib 80 is to make angular displacement in the closing direction A2, the respective slide portions 15a, 23a of the first and second sliding members 15, 23 get over an apex of the projection 81 from the closing-direction side portion 84 of the projection 81 to slide on the opening-direction side portion 83 of the projection 81.

Since inclined surfaces of the opening-direction side portion 83 and the closing-direction side portion 84 of the projection 81 are different in inclination from each other and the closing-direction side portion 84 is large in inclination as compared with the opening-direction side portion 83, the respective slide portions 15a, 23a of the first and second sliding members 15, 23 need a great force in getting over the apex when the rib 80 makes angular displacement in the closing direction A2 as compared with the case where the rib 80 makes angular displacement in the opening direction A1. Thereby, a coefficient of friction in the case where the rib 80 makes angular displacement in the opening direction A1 can be made small and a coefficient of friction in the case where the rib 80 makes angular displacement in the closing direction A2 can be made large.

Accordingly, a frictional force acting due to the own weight of the panel unit portion 3 in the closing direction A2 can be made larger than a frictional force acting in the opening direction A1. With the use of such projections 81 provided on the rib 80, the panel unit portion 3 can be prevented from making angular displacement due to the own weight in the closing direction A2, a small force can cause the panel unit portion 3 to make angular displacement in the opening direction, and the panel unit portion 3 can smoothly make angular displacement.

Also, while inclination of the plurality of projections 81 formed on the surfaces of the rib 80 is directional in the embodiment shown in FIG. 12, the invention is not limited to such measure but applicable to other measure, in which a coefficient of friction is directional, as well as the above measure, in which the projections are differently inclined in directions. Also, such measure is not limited to setting of the rib 80 but it is needless to describe in detail that such measure can be formed on the slide portions 15a, 23a, at which the first and second sliding members 15, 23 contact with the rib 80. Also, the configuration except the rib 80 may adopt the configuration of the sliding members and the energizing casing shown in FIGS. 4, 5, 6 to 8, 9, 10 and 11.

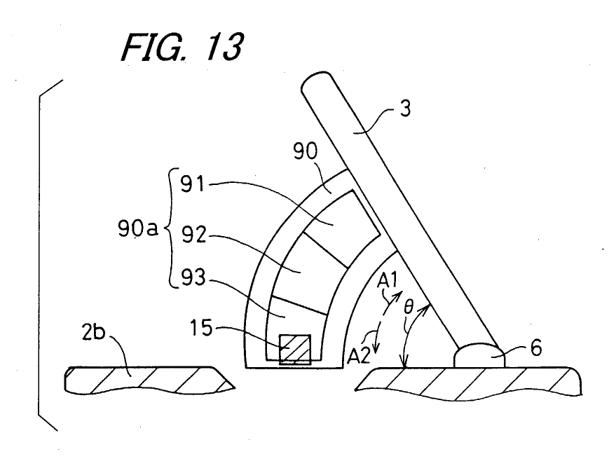

FIG. 13 is a side view showing a rib 90 according to a further embodiment of the invention. A plurality of friction regions having different coefficients of friction in a circumferential direction are formed on slide portions 90a of the rib 90, on which the first and second sliding members 15, 23 slide. The plurality of friction regions are provided in such a manner that adjacent friction regions are different in coefficient of friction. For example, as shown in FIG. 13, a first friction region 91, a second friction region 92, and a third friction region 93 are formed in this order as they go away from the panel unit portion 3 in the circumferential direction. In the case where the above arrangement is applied to, for example, a panel unit portion 3 having a display portion 4, a coefficient of friction on a friction region corresponding to that position of angular displacement, in which the panel unit portion 3 is held in a high probability, is increased whereby no uniform holding force is obtained over all positions of angular displacement of the panel unit portion 3 but a holding force can be easily increased in a position of angular displacement, in which the panel unit portion 3 is held. Thus, the coefficients of friction are decreased on friction regions corresponding to other positions of angular displacement than a position of angular displacement, in which the panel unit portion 3 is held, whereby a small force can cause the panel unit portion 3 to make angular displacement to a position, in which the panel unit portion is to be held. For example, with an arrangement, in which regions are formed to have a small coefficient of friction and a large coefficient of friction so that angular displacement is effected due to the own weight of the panel unit portion 3 in a region with a small coefficient of friction, the panel unit portion 3 is held in a position, in which a coefficient of friction is large, and a position of angular displacement of the panel unit portion 3 can be switched over in a stepwise manner in a simple configuration.

Also, for example, by making a coefficient of friction of the friction region 91 on an opening side of the rib 90 larger than that of the friction region 93 on a closing side of the rib, a friction force can be increased when the panel unit portion 3 is present in a position of angular displacement near the horizontal since the friction region 91 on the opening side has a large coefficient of friction. Thereby, a holding force can be increased even in the case where the panel unit portion 3 subjected to an overturning moment is present in a position of angular displacement near the horizontal.

Also, with the above measure, the plurality of friction regions 91 to 93 are provided to be arranged such that adjacent friction regions are different in frictional quality, other measure can be also embodied. For example, a plurality of friction regions different in axial dimension, that is, a dimension in a thickness direction, in the circumferential direction may be formed on the slide portions 90a of the rib 90, on which the first and second sliding members 15, 23 slide. In other words, surfaces of the slide portions 90a of the rib 90 may be formed to be inclined in the axial direction B as they go in the circumferential direction.

For example, by making a dimension in a thickness direction of the friction region 91 on the opening side of the rib 90 larger than that of the friction region 93 on the closing side, the first sliding member 15 is displaced upstream in a bias direction when the panel unit portion 3 is present in a position of angular displacement near the horizontal, so that a pressing force on the rib 12 is increased to enable increasing a frictional force on the rib 12. Thereby, even in the case where the panel unit portion 3 subjected to a large overturning moment is present in a position of angular displacement near the horizontal, it is possible to increase a holding force. Further, it is preferable that boundaries between adjacent regions having different thicknesses be changed not sharply but gently and continuously in thickness and discontinuous steps be small in the boundaries. Also, it is preferable that a diametrical thickness in the radial direction of the rib 12 be changed gently. Thereby, the panel unit portion 3 can make angular displacement smoothly.

In this manner, by varying a coefficient of friction and a pressing force on the rib 12 according to a position of angular displacement of the panel unit portion 3, it is possible to prevent loss of a holding force for a tilt angle due to the own weight of the panel unit portion 3.

The above embodiments are exemplary of a tilting mechanism for a display mounted on electronic apparatuses, and the invention is not limited thereto. Various modifications of the embodiment, such as applications to angular adjustment of a sheet feed mechanism in other electronic apparatuses, business machines, or the like, not to mention provision of the tilt function of the invention on the sheet feeding portion 10 shown in FIG. 1, are possible within a scope not departing from the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An electronic apparatus comprising:
an electronic apparatus body;
a tilting portion supported in a support position on the electronic apparatus body to be capable of angular displacement around an axis of angular displacement;
a projecting member projecting from the tilting portion in a direction perpendicular to the axis of angular displacement; and
position holding means having a sliding member, which elastically comes into surface contact with the projecting member in a different position from the support position.

2. The electronic apparatus of claim 1, wherein the projecting member has an arcuate, outer peripheral surface centering about the axis of angular displacement.

3. The electronic apparatus of claim 1, wherein the tilting portion is supported in the support position, which is axially symmetrical with respect to the projecting member, to be able to make angular displacement.

4. The electronic apparatus of claim 1, wherein at least one of a slide portion of the sliding member on which the projecting member slides and a slide portion of the projecting member on which the sliding member slides, is formed to be roughened.

5. The electronic apparatus of claim 1, wherein at least one of a slide portion of the sliding member on which the projecting member slides and a slide portion of the projecting member on which the sliding member slides, is formed of a material providing a large coefficient of friction between the slide portions such that a frictional force capable of preventing displacement of the tilting portion due to its own weight can be obtained.

6. The electronic apparatus of claim 1, wherein a plurality of projections are formed on at least one of a slide portion of the sliding member on which the projecting member slides and a slide portion of the projecting member on which the sliding member slides, and the respective projections are formed to be asymmetrical in a circumferential direction.

7. The electronic apparatus of claim 1, wherein at least one of a slide portion of the sliding member on which the projecting member slides and a slide portion of the projecting member on which the sliding member slides, is configured such that a coefficient of friction between the slide portions is varied depending upon an angular position of the tilting portion.

8. The electronic apparatus of claim 7, wherein the coefficient of friction is increased as a location of the center of gravity of the tilting portion at the time of installation of the electronic apparatus becomes more distant from a vertical plane including the axis of angular displacement.

9. The electronic apparatus of claim 1, wherein the position holding means comprises a spring force generating portion for giving a spring force to the sliding member in an energizing direction toward the projecting member along an axial direction such that as the sliding member is positioned upstream in the energizing direction, a large spring force is applied to the sliding member, and
at least one of a slide portion of the sliding member on which the projecting member slides and a slide portion of the projecting member on which the sliding member slides, is formed to be inclined in one sense of the axial direction as it goes in one sense of the circumferential direction.

10. The electronic apparatus of claim 1, wherein the position holding means comprises two sliding members for elastically sandwiching therebetween the projecting member on both sides thereof in the axial direction.

11. The electronic apparatus of claim 10, wherein the position holding means comprises two sliding members held by a single holding member to be made a unit.

12. The electronic apparatus of claim 11, wherein the holding member has flexibility and elasticity, and an elastic recovery force of the holding member causes the respective sliding members to elastically sandwich therebetween the projecting member.

13. The electronic apparatus of claim 1, wherein the projecting member is sized in the axial direction such that a radially inward portion thereof is formed to be larger than a radially outward portion thereof.

14. The electronic apparatus of claim 1, wherein the position holding means comprises:
a spring force generating portion for generating a spring force in an energizing direction in parallel to the axis of angular displacement and toward the projecting member; and
a pressing force changing portion for changing a pressing force, with which the spring force generated by the spring force generating portion causes the sliding member to press the projecting member, between a case where the projecting member makes angular displacement in one sense of the circumferential direction and a case where the projecting member makes angular displacement in the other sense of the circumferential direction.

15. The electronic apparatus of claim 14, wherein the pressing force changing portion comprises a fixed guide provided on an electronic apparatus body and a sliding-member guide provided on the sliding member, and
the fixed guide and the sliding-member guide abut against each other in the circumferential direction, and at least one of the guides guides the other of the guides in one sense of the axial direction as it goes in one sense of the circumferential direction.

16. The electronic apparatus of claim 14, wherein the pressing force changing portion is configured such that a pressing force when a location of the center of gravity of the tilting portion at the time of installation of the electronic apparatus is displaced in a direction more distant from a vertical plane including the axis of angular displacement is made larger than a pressing force when the location of the center of gravity of the tilting portion at the time of installation of the electronic apparatus is displaced in a direction more close to the vertical plane including the axis of angular displacement.

17. The electronic apparatus of claim 1, wherein the tilting portion comprises display means for displaying a picture image.

18. The electronic apparatus of claim 1, wherein the tilting portion comprises a sheet feeding portion for taking sheets into the electronic apparatus body from outside thereof.

19. The electronic apparatus of claim 15, wherein at least one of the fixed guide and the sliding-member guide has an inclined surface which inclines relative to the axial direction, and an angle of inclination of the inclined surface relative to the axial direction is set in a range of from 30 degrees to 60 degrees.
